(19) United States
(12) Patent Application Publication
(10) Pub. No.: US 2021/0394405 A1
(43) Pub. Date: Dec. 23, 2021

(54) VARIABLE PROFILE FORMING APPARATUS AND METHOD

(71) Applicant: EuroLeisure Investments Ltd, Auckland (NZ)

(72) Inventor: Ivan ERCEG, Auckland (NZ)

(21) Appl. No.: 17/289,785

(22) PCT Filed: Oct. 30, 2019
(86) PCT No.: PCT/IB2019/059283

§ 371 Date: Apr. 29, 2021

(30) Foreign Application Priority Data
Oct. 30, 2018 (NZ) 747826

(51) Int. Cl. B29C 43/58; B29C 43/22; B29C 43/52; B29C 33/30

(52) U.S. Cl. CPC B29C 43/58; B29C 43/228; B29C 43/52; B29C 2043/3266; B29C 2043/5833; B29C 2043/5891; B29C 33/308

(57) ABSTRACT

An apparatus and process for forming material, the apparatus or process comprising at least one forming unit, each said forming unit having at least one forming opening to receive a feed of material to be formed, the at least one of said forming opening(s) comprises opposing or at least one forming surfaces, at least one of said opposing forming surfaces being dynamically controllable into a pre-determined shape or profile to impart a resultant shape or profile of a pre-determined formation upon the feed of material passing through said forming opening of a said forming unit.

### CROSS-REFERENCE TO RELATED APPLICATIONS

The present Utility patent application is the National Phase filing under 35 U.S.C. 371 of the International Application No PCT/IB2019/059283 filed Oct. 30, 2019 entitled “VARIABLE PROFILE FORMING APPARATUS AND METHOD”, which PCT in turn claims priority to New Zealand Patent Application Number 747826 filed on Oct. 30, 2018. The contents of these related New Zealand and PCT applications are incorporated herein by reference for all purposes to the extent that such subject matter is not inconsistent herewith or limiting hereof.

### TECHNICAL FIELD

The present disclosure generally relates to an apparatus and method of forming three-dimensional articles in a continuous or semi-continuous manner.

### BACKGROUND

Forming of materials is a process integral to the manufacture of various components and products in various industries. Traditional approaches to forming components may involve forming moulded articles by processes such as press forming and injection moulding.

### SUMMARY OF THE INVENTION

It is an object of the present invention to provide an apparatus, or a method, or a process for forming of an article which goes at least some way toward overcoming limitations of the prior art or at least which will provide the public with a useful choice.

In a first aspect of the invention there is provided an apparatus for forming material, the apparatus comprising:

at least one forming unit, each said forming unit having at least one forming opening to receive a feed of material to be formed,

wherein at least one of said forming opening(s) comprises opposing forming surfaces,

at least one of said opposing forming surfaces being dynamically controllable into a pre-determined shape or profile to impart a resultant shape or profile of a pre-determined formation upon the feed of material passing through said forming opening of a said forming unit.

In a second aspect of the invention there is provided a process for forming material on a continuous or semi-continuous basis, the process comprising: directing a feed of material to be formed to at least one forming unit, each said forming unit having at least one forming opening to receive the feed of material to be formed, wherein at least one of said forming opening(s) comprises opposing or at least one forming surfaces, at least one of said opposing forming surfaces being dynamically controllable into a pre-determined shape or profile to impart a resultant shape or profile of a pre-determined formation upon the feed of material passing through said forming opening of a said forming unit.

The following applies in respect of the above aspects.

In some embodiments, a pair of opposing forming surfaces are individually and dynamically controllable into a pre-determined shape or profile to impart a resultant shape or profile of a pre-determined formation upon the feed of material passing through said forming opening of a said forming unit.

In some embodiments, said apparatus comprises a material advancer for advancing a feed of material to be formed to said opening of a said forming unit.

In some embodiments, the material advancer is configured to advance the material to be formed towards and/or through the at least one forming opening of the at least one forming unit, so as to form the material into the pre-determined formation.

In some embodiments, the material is imparted with a pre-determined formation from each said forming unit.

In some embodiments, the material is sequentially fed through a sequentially arranged series of forming units, each said forming unit imparting the same or a different pre-determined formation to said material.

In some embodiments, said material achieves a resultant formation from a sequential application of forming forces imparted by a sequentially arranged series of said forming units.

In some embodiments, the apparatus comprises a controller.

In some embodiments, the controller is configured to modify the cross-sectional shape of the forming unit, optionally, along a predefined direction.

In some embodiments, the forming opening is configured to apply pressure or force to the material to be formed.

In some embodiments, the pressure or force changes the profile of the material to be formed as it passes through the forming opening.

In some embodiments, the pressure or force promotes consolidation of the material to be formed.

In some embodiments, the pressure or force is applied via vibrations or micro-vibrations.

In some embodiments, one or more materials may be provided to the forming unit as said feed of material.

In some embodiments, the one or more materials are formed into a consolidated material by the forming unit.

In some embodiments, the at least one forming opening comprises an inlet and an outlet, the material being configured to be passed through the inlet of the at least one forming opening and out the outlet of the at least forming opening.

In some embodiments, there are a plurality of forming openings.

In some embodiments, the forming opening is configured to be modifiable to vary the size and or shape of the forming opening.

In some embodiments, the forming unit comprises inlet actuators configured to modify or vary the cross-sectional area of the or an inlet of the at least one forming opening.

In some embodiments, the forming unit comprises outlet actuators configured to modify or vary the cross-sectional area of the or an outlet of the at least one forming opening.

In some embodiments, the forming unit comprises at least one module, the at least one module configured to define a surface of profile of the forming opening.

In some embodiments, the forming unit comprises an upper or top module, the upper or top module configured to define an upper or top profile of the forming opening.

In some embodiments, the forming unit comprises a lower or bottom module, the lower or bottom module configured to define a lower or bottom profile of the forming opening.

In some embodiments, the upper or top module is a mirror image of the lower or bottom module.

In some embodiments, the upper or top module and the lower or bottom module are substantially the same width and length.

In some embodiments, a width of the upper or top module and the lower or bottom module is substantially the same as the material to be formed.

In some embodiments, the forming unit comprises one or more side module(s), the side module(s) configured to define one or more sides of the forming opening.

In some embodiments, the one or more side modules comprise a first side module and a second side module.

In some embodiments, the first side module and second side module are located on opposite sides of the forming opening.

In some embodiments, the forming unit comprises at least one actuator, the at least one actuator configured to modify or vary the cross-sectional area of the forming opening.

In some embodiments, the at least one actuator may be configured to modify the pre-determined shape or profile of the forming surfaces.

In some embodiments, an end surface of the actuator is configured to define at least part of the pre-determined shape or profile of the forming surfaces.

In some embodiments, at least one actuator comprises an end cap, the end cap defining the end surface of the actuator.

In some embodiments, the end cap is connectable and disconnectable from the at least one actuator.

In some embodiments, a profile and/or surface of the end cap is dynamically controllable.

In some embodiments, the end cap is connectable to and disconnectable from one or more end cap of an adjacent actuator(s).

In some embodiments, each end cap comprises a connection feature (optionally a channel), the connection feature allowing for connection and disconnection between the end cap of adjacent actuator(s).

In some embodiments, a plurality of connected end caps forms said forming surface.

In some embodiments, the or at least one module comprises at least one actuator module, the actuator module comprising at least one actuator.

In some embodiments, the or an upper or top module comprises an upper or top actuator module, the upper or top actuator module comprising at least one actuator.

In some embodiments, the or a lower or bottom module comprises a lower or bottom actuator module, the lower or bottom actuator module comprising at least one actuator.

In some embodiments, the or one or more side module(s), comprises a side actuator module the side actuator module comprising at least one actuator.

In some embodiments, each actuator or a group of actuators, or the actuator module is configured to be independently controlled.

In some embodiments, each actuator or a group of actuators, or the actuator module is configured to be moveable (optionally along a length and/or width of the material).

In some embodiments, each actuator or a group of actuators, or the actuator module is configured to be moveable in a direction along the apparatus, and/or a direction parallel to the apparatus.

In some embodiments, each actuator or a group of actuators, or the actuator module is configured to be movable by one or more actuators.

In some embodiments, a first actuator or a first group of actuators, or a first actuator module is configured to be controlled independently from a second actuator or a second group of actuators, or second actuator module.

In some embodiments, the first actuator or the first group of actuators, or the first actuator module is controlled to engage a surface of the material, while the second actuator or the second group of actuators, or the second actuator module is being moved to a desired position.

In some embodiments, the second actuator or the second group of actuators, or the second actuator module is controlled to engage a surface of the material, while the first actuator or the first group of actuators, or the first actuator module is being moved to a desired position.

In some embodiments, the or a controller is configured to control the position of at least one actuator to modify or vary the cross-sectional area of the forming opening.

In some embodiments, the at least one actuator is controlled by the or a controller to reach a first predetermined location (or a first desired stroke length).

In some embodiments, the first predetermined location corresponds to or with a material hold position.

In some embodiments, the at least one actuator is controlled by the controller to apply a predetermined forming force to the material to be formed.

In some embodiments, the predetermined forming force is applied to the material to be formed by advancing to a second predetermined location (or a second desired stroke length). In some embodiments, the predetermined forming force is applied to the material to be formed by advancing between at least a first and a second predetermined location of the actuator (or at least a first and a second desired stroke length).

In some embodiments, the predetermined forming force is applied to the material to be formed by pulsing or vibrating between at least a first and a second predetermined location of the actuator (or at least a first and a second desired stroke length).

In some embodiments, the predetermined forming force is applied to the material to be formed based on an output from a force sensor (optionally the force sensor being located in the actuator and/or forming unit or product or material to be formed).

In some embodiments, the or a controller is configured to control the actuator to apply said predetermined forming force for a predetermined time.

In some embodiments, the at least one actuator is controlled by the controller to reach a third predetermined location (or a third desired stroke length).

In some embodiments, the third predetermined location corresponds to or with a material hold position.

In some embodiments, the controller is configured to control the or a actuator in accordance with an actuator control scheme, said actuator control scheme being to move to said or a first predetermined location, then apply said or a predetermined forming force for said predetermined amount of time, and then move to said or a third predetermined location.

In some embodiments, said actuator control scheme is undertaken continuously.

In some embodiments, the material is advanced between each actuator control scheme

In some embodiments, the one or more of:
the first predetermined location,
predetermined forming force (or the second predetermined location),
the third predetermined location,

is controlled to be varied for each actuator control scheme.

In some embodiments, the predetermined forming force increases or decreases for each actuator control scheme.

In some embodiments, the actuator control scheme further comprises apply a first predetermined forming force, followed by a one or more further predetermined forming force(s).

In some embodiments, the actuator control scheme further comprises moving the actuators to a material hold position between each application of a forming force.

In some embodiments, the first predetermined force is larger or smaller than the one or more further predetermined forming force(s).

In some embodiments, the controller is configured to determine or calculate said actuator control scheme, in accordance with the profile of the material as formed, or the material to be formed.

In some embodiments, the actuators are configured to engage a surface of the material substantially concurrently, so as to apply said forming force concurrently.

In some embodiments, the concurrent application in force across the width of the material is configured prevents the application of a localised force.

In some embodiments, at least one actuator comprises at least one swivelling portion, optionally the at least one swivelling portion is configured to be moveable in at least one degree of freedom (optionally one degree of freedom, or two degrees of freedom, or three degrees of freedom, or four degrees of freedom, or five degrees of freedom, or six degrees of freedom).

In some embodiments, the swivelling portion is located at an end and/or a base of said at least one actuator.

In some embodiments, the at least one swivelling portion comprises a resilient membrane.

In some embodiments, a heat protection layer, or heat shield is provided over and/or the resilient membrane.

In some embodiments, the heat protection layer, or heat shield comprises a metal foil layer, or a ceramic layer.

In some embodiments, the heat protection layer, or heat shield mitigates or prevents heat transfer from the material to be formed.

In some embodiments, there are a plurality of actuators.

In some embodiments, each actuator comprises an associated swivelling portion.

In some embodiments, each actuator and/or the forming surface is provided with a releasing agent, the releasing agent configured to allow for release of the actuator and/or the forming surface from the resilient membrane and/or the material to be formed.

In some embodiments, the forming apparatus or forming apparatus comprises at least one resilient membrane

In some embodiments, the at least one resilient membrane is provided (optionally on an inner surface of the at least one resilient membrane) with at least one release film and/or at least one release fabric configured to contact a surface of the material to be formed,

In some embodiments, the at least one release film and/or the at least one release fabric is configured to allow for the release of the resilient membrane from the material to be formed.

In some embodiments, the resilient membrane comprises an upper resilient membrane and a lower resilient membrane.

In some embodiments, the upper resilient membrane and the lower resilient membrane form an enclosed resilient membrane (optionally the upper resilient membrane and the lower resilient membrane are joined at or along at least one edge).

In some embodiments, the resilient membrane is formed over said plurality of actuators, or said associated swivelling portions, the resilient membrane defining a surface for contact with the material to be formed.

In some embodiments, the resilient membrane overlays the at least one forming surface, and/or plurality of actuators and/or said associated swivelling portions.

In some embodiments, the or a lower or bottom module and/or a lower or bottom forming surface comprises a lower or bottom resilient membrane.

In some embodiments, the lower or bottom resilient membrane defines a lower or bottom surface of the forming opening

In some embodiments, the side module and/or a side forming surface comprises a side resilient membrane.

In some embodiments, the side resilient membrane defines a side surface of the forming opening.

In some embodiments, or the or an upper or top module and/or a upper or top forming surface comprises a upper or top resilient membrane.

In some embodiments, the upper or top resilient membrane defines a upper or top surface of the forming opening.

In some embodiments, the at least one resilient membrane comprises a heat shield

In some embodiments, the heat shield is configured to engage a surface of the material to be formed as it passes through the at least one forming opening.

In some embodiments, a vacuum is created between the resilient membrane and/or heat shield and a surface of the material to be formed, optionally the vacuum is created by a vacuum pump

In some embodiments, the resilient membrane and/or heat shield is provided with at least one vacuum port (optionally the vacuum port comprises at least one one-way valve).

In some embodiments, the vacuum port is located outside a boundary of the material to be formed.

In some embodiments, the forming apparatus comprises one or more rollers configured create said vacuum.

In some embodiments, the vacuum promotes consolidation of the material to be formed.

In some embodiments, the resilient membrane is configured to remain in contact with a surface of the material to be formed.

In some embodiments, when the or a vacuum is formed between the resilient membrane and/or heat shield and the material to be formed, and the actuators retracted, the vacuum formed maintains the resilient membrane and/or heat shield in contact with a surface of the material to be formed.

In some embodiments, the resilient membrane is connectable and disconnectable from said or a swivelling portion.

In some embodiments, the forming apparatus and/or each forming unit comprises one or more heat source(s) or heating system(s).

In some embodiments, the one or more heat source(s) or heating system(s) comprises one or more of: a microwave heating source, an infrared source, gas heating, air heating, electrical heating, induction heating, electromagnetic induction heating.

Some embodiments further comprise at least one embedded sensor in or on the material to be formed, and wherein the apparatus is configured to monitor the embedded sensor to determine a characteristic of the material to be formed.

In some embodiments the embedded sensor is one or more of: a strain sensor, a stress sensor, a temperature sensor, a pressure sensor, a force sensor, a light sensor, a UV sensor, or another sensor applicable to product manufacture and/or life cycle.

In some embodiments the or a controller is configured to receive a signal from said one or more embedded sensor(s) indicative of the characteristic of the material to be formed, and control the apparatus based on the signal.

In some embodiments, each forming unit comprises one or more temperature sensors configured to monitor the temperature of a surface, and/or a core of the material to be formed.

In some embodiments, the apparatus is divided into a series of zones, said zones being a lengthwise portion of the apparatus, each zone comprising at least heat source(s) or heating system(s) and at least one temperature sensor configured to monitor the temperature of a surface, and/or a core of the material to be formed.

In some embodiments, the or a controller is configured to receive a signal from said one or more temperature sensors indicative of the temperature of the material to be formed, and based on the signal control the power provided to the heat source(s) or heating system(s).

In some embodiments, the temperature sensor comprises one or more of: an infrared temperature sensor, an optical temperature sensor, a microwave measuring system.

In some embodiments, the or a controller controls the power provided to the heat source(s) or heating system(s), based on a difference between the signal received from said one or more temperature sensors indicative of the temperature of the material to be formed and a desired temperature.

In some embodiments, the heat source or heating system is located in one or more of:
the upper or top module, and/or the upper or top forming surface,
the lower or bottom module, and/or the lower or bottom forming surface,
the side module(s), and/or the side forming surface,
a or the zone of said apparatus (optionally said zone being a lengthwise portion of the apparatus).

In some embodiments, there are a plurality of forming units.

In some embodiments, the plurality of forming units are arranged in series, such that the material passes through a first forming unit, and to subsequent further forming units.

In some embodiments, the plurality of forming units are configured to gradually change the profile of the material gradually as the material is passed through each of said plurality of forming units.

In some embodiments, the material to be formed is of a first profile, and wherein each forming unit is configured to form the material to a corresponding intermediate profile, and wherein the final forming unit of the plurality of forming units is configured to form the material to a final profile.

In some embodiments, the forming opening of a penultimate forming unit has the same shape as the forming opening of a final forming unit.

In some embodiments, a forming unit of said at least one forming unit is configured to transfer said material to be formed to an adjacent forming unit of said at least one forming unit.

In some embodiments, the forming unit of said at least one forming unit is configured to transfer the material to be formed by moving from a first location towards a second location, the second location being adjacent the adjacent forming unit so as to provide the material to be formed to the adjacent forming unit and/or advance the material to be formed.

In some embodiments, on transfer from a forming unit to an adjacent forming unit, the adjacent unit is configured to engage the material to be formed, and wherein after the engagement between the adjacent forming unit and the material to be formed has been created an engagement between the first forming unit and the material to be formed is released.

In some embodiments, said engagement is a vacuum or a negative pressure device.

In some embodiments, subsequent to transfer of the material to be formed from the forming unit is configured to move from the second location towards the first location.

In some embodiments, there are a plurality of forming units and each forming unit is configured to the transfer of said material to be formed an adjacent forming unit in a staggered manner.

In some embodiments, the forming opening is configured to be modifiable to vary the location and/or orientation of the forming opening relative to the material to be formed as it is advanced.

In some embodiments, each, or a group of said at least one forming units is supported by a forming unit support, optionally, the forming unit support comprises a plate, or a rail.

In some embodiments, the at least one forming unit, or the forming unit support is connected to, or carried by at least one robotic arm, optionally the forming unit or the forming unit support is connected to the robotic arm via an robot end effector.

In some embodiments, the at least one forming unit, or forming unit support is moved by said robotic arm.

In some embodiments, the least one forming unit is actuated by at least one actuator, to adjust the location of the forming opening relative to the material to be formed.

In some embodiments, the at least one actuator comprises one or more of:
a vertical actuator configured to vertically modify the location of the forming unit and/or forming opening relative to a vertical reference plane (i.e. a plane perpendicular to a ground plane),
a horizontal actuator configured to horizontally modify the location of the forming unit and/or forming opening relative to a horizontal reference plane (i.e. a plane parallel to a ground plane),
a tilt actuator configured to tilt the forming unit and/or forming opening relative to a reference plane (i.e. a ground plane).

In some embodiments, the at least one forming unit is configured to actuated by said at least one actuator over a predetermined path (optionally by a or the controller).

In some embodiments, a velocity of the at least one forming unit along said predetermined path is based on one or more of:
the speed at which the apparatus advances the material to be formed,
the speed at which the material to be formed is provided to the apparatus,
the temperature of a part of the material to be formed (for example a core temperature or a surface temperature),
at least one output of the or a measurement module.

In some embodiments, the actuation of the or each forming unit is configured to create a varying shape or profile of the material to be formed.

In some embodiments, the material is advanced at a continuous rate.

In some embodiments, the material is advanced at about 3 metres/minute.

In some embodiments, the rate at which the material is advanced is based on one or more of:
actuator speed (for example the speed at which the actuators can proceed through an actuator control scheme either as a maximum speed or a controlled speed),
the number of actuators (for example the number of actuators which form a forming surface),
an amount of heat supplied, or able to be supplied by the heating source,
a vacuum supplied, or able to be supplied by the vacuum source.

In some embodiments, one or more forming units at the end of the plurality of forming units are configured to be moved by said actuator to shape a final profile of the material to be formed.

In some embodiments, the movement of said one or more forming units at the end of the plurality of forming units is controlled by said actuator to provide for one or more of:
a substantially continuously curved profile,
a substantially concave or convex profile,
a profile comprising a curved portion (for example a compound curve),
a profile comprising at least one substantially straight portion.

In some embodiments, the forming apparatus is configured to form the material to be formed into a plurality of portions, each of the plurality of portions having an associated profile or cross-section,

In some embodiments, the associated profile or cross-section of each of the plurality of portions are different

In some embodiments, the forming apparatus is configured to form the material to be formed into at least a first portion having a first profile, a second portion having a second profile, and a third portion having a third portion.

In some embodiments, the first profile, the second profile and the third profile are different

In some embodiments, the forming apparatus is configured to form the material to be formed into at least a subsequent portion having an associated subsequent profile.

In some embodiments, the forming apparatus comprises an automated machine tool station configured to trim, and or cut and or drill apertures in the material as formed.

In some embodiments, the automated machine tool station comprises a Computer numerical control (CNC) machine

In some embodiments, the automated machine tool station comprises a laser or water cutting system.

In some embodiments, the advancer is one or more of:
a roller, or an intelligent roller system,
one or more conveyers (optionally located before, after or between forming units,
the movement of the plurality of forming units,
at least one fastening device (for example a clamp or brace or the or a stretch unit configured to apply tension to the material to be formed) optionally, the fastening device configured to fasten with or to the material to be formed and advance to advance the material to be formed,
an edge actuator (optionally as part of the module) configured to engage an edge of the material to be formed (optionally the edge actuators comprise a pair of opposing edge actuators configured to engage opposing sides of the material to be formed).

In some embodiments, the actuators and/or one or more forming units are or comprises a roller or set of rollers.

In some embodiments, the apparatus comprises at least one cooling system, configured to cool the material.

In some embodiments, the at least one cooling system is configured to cool the material once it passes through said at least one forming unit.

In some embodiments, the controller is configured to control the at least one cooling system to cool the material in accordance with a cooling profile,

In some embodiments, the controller is configured to control the at least one cooling system to control the removal of heat from the material to be formed or as formed.

In some embodiments, the controller is configured to control the at least one cooling system based on an output of the measurement module (for example a temperature).

In some embodiments, the at least one cooling system comprises one or more of: air cooling, water cooling, turbulent water cooling, a water jacket, nitrogen cooling, ice cooling.

In some embodiments, the at least one cooling system is provided to the resilient membrane and/or the resilient membrane by at least one roller system.

In some embodiments, the apparatus further comprises at least one measurement module, wherein the measurement module measures characteristics of the material to be formed during forming, and/or the material as formed.

In some embodiments, there is provided a measurement system as part of the or a material preparation module and/or the pre-forming module and/or the apparatus.

In some embodiments, the measurement module comprises at least one laser measurement system, or computer vision or robotically observable measurement.

In some embodiments, the measurement system is configured to measure one or more of the following characteristics: fibre orientation or fibre alignment, weave orientation or weave alignment, material thickness material width, material length, material cross-sectional profile, material side profile, fibre or material quality, material surface temperature (optionally a lower surface, and/or an upper surface of the material), material core temperature, a pressure applied to the material to be formed (optionally by the forming unit, and/or by said vacuum), a tension applied to the material to be formed (optionally by the forming unit and/or the stretch unit), material compression or material crystallisation, any air pockets or voids in the material, stretch or material strength.

In some embodiments, the controller is configured to receive an input from said measurement system relating to a characteristic of the material to be formed, and optionally the location of measurement of the characteristic, and wherein the controller is configured to change or control an output in response to said input.

In some embodiments, the controller is configured to change the or an output to control one or more of:
the speed at which the apparatus advances the material to be formed,
the speed at which the material to be formed is provided to the apparatus based on an output of the measurement system,
a pressure applied to the system by the at least one forming unit,
a tension applied to the material to be formed (optionally by the forming unit and/or the stretch unit),
a material surface temperature (optionally a lower surface, and/or an upper surface of the material),
a material core temperature,
an alignment or orientation of the material to be formed relative to the apparatus and/or at least one forming unit.

In some embodiments, the controller or measurement system is configured to compare a measured characteristic against a predetermined characteristic, and modify and output of the apparatus based on a difference between the measured characteristic and the predetermined characteristic.

In some embodiments, the controller or measurement system is configured to compare a measured characteristic against a predetermined characteristic, and provide a user with an output if the measured characteristic is not within a tolerance of the predetermined characteristic.

In some embodiments, the tolerance includes an allowance for shrinkage or spring back of material.

In some embodiments, the controller is configured to control one or more outputs of the apparatus based on one or more inputs, wherein the one or more inputs comprise:
a desired profile or shape of the material to be formed,
a weave direction or layout (optionally along a width or length of the material to be formed),
a difference in material properties or type along a width or length of the material to be formed,
an amount of desired material compression.

In some embodiments, the apparatus is configured to apply tension to the material to be formed.

In some embodiments, the tension applied to the material to be formed is in at least one direction, the at least one direction being one or more of:
along a length of the material to be formed,
along a width of the material to be formed,
along a height of the material to be formed,

in the direction the material is advanced

In some embodiments, the at least one forming unit is configured to apply said tension to the material to be formed.

In some embodiments, the apparatus comprises a stretch unit configured to apply said tension to the material to be formed.

In some embodiments, the stretch unit advances the material to be formed.

In some embodiments, the stretch unit is an intelligent conveyor system.

In some embodiments, the stretch unit comprises at least one fastening device (for example a clamp or brace or gripper) optionally, the fastening device configured to fasten with or to the material to be formed and advance the material to be formed.

In some embodiments, the fastening device comprises at least one programmable or controllable fastening device, and optionally wherein the controller is configured to control the at least one programmable or controllable fastening device.

In some embodiments, the stretch unit comprises a least one pressure or force sensor, wherein the pressure or force sensor is configured to measure the tension provided to the material to be formed.

In some embodiments, the at least one forming unit is configured to engage opposing surfaces of the material to be formed.

In some embodiments, the tension provided is constant along the length of the apparatus

In some embodiments, the tension varies along the length of the apparatus

In a third aspect of the invention there is provided a system, wherein the system comprises one or more of the apparatus of any one of the preceding claims.

The following apply in respect of the prior aspects.

In some embodiments, an output material of one or more apparatus is provided as an input material to a subsequent apparatus.

In some embodiments, the system comprises at least a first apparatus as the one or more apparatus and a second apparatus as the one or more apparatus.

In some embodiments, the first apparatus and second apparatus are arranged in parallel.

In some embodiments, the first apparatus is configured to receive a first material as a material to be formed, and wherein the second apparatus is configured to receive a second material as a material to be formed.

In some embodiments, the first apparatus is configured to impart a first resultant shape or first profile of a pre-determined formation upon the first material.

In some embodiments, the second apparatus is configured to impart a second resultant shape or first profile of a pre-determined formation upon the second material.

In some embodiments, the system comprises a third apparatus or consolidation apparatus as the one or more apparatus, the third apparatus being configured to receive the first material and the second material, and form the first material and second material into a consolidated material.

In some embodiments, the first material and second material are formed into a consolidated material by one or more of:
application of a or the forming force,
application of heat (optionally by the heating source or heating system).

In a fourth aspect of the invention there is provided an apparatus configured to form, as a material to be formed, on or more of:
a thermoplastic or thermoset material,
a hybrid thermoplastic material,
a metal core material,
a thermoplastic or thermoset core material,
a composite material.

The following apply in respect of the above aspects.

In some embodiments, the material to be formed may comprise one or more of: tape, carbon fibre, woven fibre, reinforced fibre, fabric, metal, a composite material, unidirectional fibres.

In some embodiments, the apparatus further comprises a roller system and/or a vacuum system configured to remove air between multiple layers.

In some embodiments, the apparatus comprises at least one heating source or heating system, wherein the heating source is configured to heat the thermoplastic material.

In some embodiments, the apparatus comprises a plurality of heating sources or heating systems arranged in series.

In some embodiments, the heat provided by the heating source or heating system is configured to allow for consolidation of the material to be formed

In a fifth aspect of the invention there is provided an apparatus for supporting a formed material once is has passed through a forming process, the apparatus comprising:

at least one support unit configured to support the formed material once it has passed through the at least one forming opening of the at least one forming unit

The following also apply in respect of the above aspects.

In some embodiments, the support unit if dynamically configurable so as to provide for a support surface corresponding with the profile of the material as formed.

In some embodiments, the support unit comprises one or more advancing actuators configured to advance the support unit with the material.

In some embodiments, the support unit is configured to support and/or move the material as formed from an end of the forming apparatus.

In some embodiments, the at least one support unit comprises at least one vacuum cup configured to engage with a surface of the formed material.

In some embodiments, the apparatus comprises a plurality of support units arranged in series and/or a grid like pattern.

In some embodiments, the at least one support unit provides a continuous or non-continuous support surface.

In some embodiments, the support surface is configured to match a profile of the material to be formed.

In some embodiments, the support surface is supported by one or more actuators configured to modify the profile of the support surface.

In some embodiments, the support unit comprises as least one gantry system.

In some embodiments, the material to be formed is of a substantially uniform cross-section.

In some embodiments, the material to be formed is has a substantially rectangular cross section, optionally the material to be formed is a constant thickness, and/or width.

In some embodiments, one or more of:
the width of the material to be formed,
the thickness of the material to be formed,
vary along the length of the material to be formed.

In some embodiments, the material to be formed comprises a fibre layer and/or a core layer.

In some embodiments, the material to be formed comprises one or more of: tape, carbon fibre, woven fibre, reinforced fibre, fabric, metal, a composite material, unidirectional fibres, a thermoplastic or thermoset resin, a core material.

In some embodiments, the material to be formed comprises a plurality of layers

In a sixth aspect there is provided a method of forming a material as defined by any of the aspects mentioned above.

In a seventh aspect there is provided a method of forming a material, the method comprising:

advancing a material to be formed through at least one forming opening having at least one forming surface,

dynamically controlling the shape or profile of the forming surface to impart a resultant shape or profile of a pre-determined formation upon the feed of material passing through said forming opening of a said forming unit.

In an eighth aspect of the invention there is provided a method of forming a material comprising: providing or directing the material to be formed to at least one forming unit, each said forming unit having at least one forming opening to receive the material to be formed, wherein at least one of said forming opening(s) comprises opposing or at least one forming surfaces, and dynamically controlling at least one of said opposing forming surfaces into a pre-determined shape or profile to impart a resultant shape or profile of a pre-determined formation upon the material passing through said forming opening of a said forming unit.

In a ninth aspect there is provided an actuator unit comprising:

a rotatable shaft,

a plate connected to the rotate shaft

at least one actuator connected to the plate.

The following applies in respect of the above aspects.

In some embodiments, the actuator unit comprises a motor, the motor configured to rotate the rotatable shaft.

In some embodiments, the actuator unit comprises a plurality of actuators connected to the plate (optionally the actuator unit comprises between 2 and 15 actuators connected to the plate).

In some embodiments, the plate is rotatably connectable and disconnectable from the rotatable shaft.

In some embodiments, the actuator unit comprises a pivotable connection between the plate and the rotatable shaft.

In some embodiments, the actuator unit comprises at least one actuator configured to modify the angle about said pivotable connection, (optionally said actuator is one or more of a hydraulic, pneumatic or electric actuator).

In some embodiments, the actuator is configured to vary in length, optionally, along a longitudinal axis.

In some embodiments, the actuator unit comprises an actuator connection, the actuator connection connecting the at least one actuator to the plate (optionally, the actuator connection is configured to be moveable in at least one degree of freedom (optionally one degree of freedom, or two degrees of freedom, or three degrees of freedom, or four degrees of freedom, or five degrees of freedom, or six degrees of freedom, or at least six degrees of freedom).

In some embodiments, the at least one actuator(s) is/are configured to engage a compliant material (optionally at an end of the actuator).

In some embodiments, the at least one actuator is configured to modify the profile of the compliant material.

In some embodiments, the at least one actuator is one or more of: a robotic end effector, a vacuum actuator, a pneumatic actuator, a muscle actuator, a servo actuator, a hydraulic actuator, a voice coil actuator, a piezo actuator, a chain actuator.

In some embodiments, the motor is one or more of: a stepper motor, a DC motor, a AC motor, an electronically controlled motor, a servo motor, a hybrid servo stepper motor, a muscle actuator, a pneumatic motor, a vacuum motor, a hydraulic motor, a voice coil motor, a piezo motor.

In some embodiments, the actuator unit comprises a housing, the housing surrounding the at least one actuator(s).

In some embodiments, the housing comprises at least one shaft aperture.

In some embodiments, the motor is configured to be operatively connected to an end of the housing at the shaft aperture.

### BRIEF DESCRIPTION OF THE DRAWINGS

FIG. 1 shows a perspective view of a forming apparatus in use.

FIG. 2 shows a top view of a forming apparatus in use.

FIG. 3 shows an example of a material being formed by a series of forming units.

FIGS. 4 and 5 show a side and perspective view of a forming apparatus in use.

FIG. 6 shows a view of a forming unit.

FIGS. 7A and 7B show views of a forming unit.

FIGS. 8A and 8B show views of a forming unit.

FIGS. 9 and 9A show views of a forming unit.

FIGS. 10-10C show various views of a forming unit in use.

FIG. 11 shows a flow chart of an actuator control scheme of a forming unit.

FIGS. 12 and 12A show cross sections of the material to be formed engaged with a resilient membrane and a forming surface.

FIGS. 13 and 13A show views of a forming unit.

FIG. 14 shows a view of a forming unit.

FIG. 15 shows a controller diagram in schematic form.

FIG. 16 shows a controller diagram in schematic form.

FIGS. 17 and 17A show views of a forming unit.

FIG. 18 shows a view of a forming unit.

FIGS. 19-19B show various layouts of a plurality of actuators.

FIGS. 20 and 20A show cross-sectional views of actuator unit.

FIG. 21 shows an example of a formed material of the claimed invention.

FIG. 21A shows examples of the actuator control/locations to achieve the formed material of FIG. 21.

FIG. 22 shows an example of a system or apparatus comprising two forming apparatuses.

FIGS. 23A and 23B show an example of an apparatus forming a material.

FIGS. 24A-24F show an apparatus forming a consolidated material.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to.”

### DETAILED DESCRIPTION OF SPECIFIC EMBODIMENTS

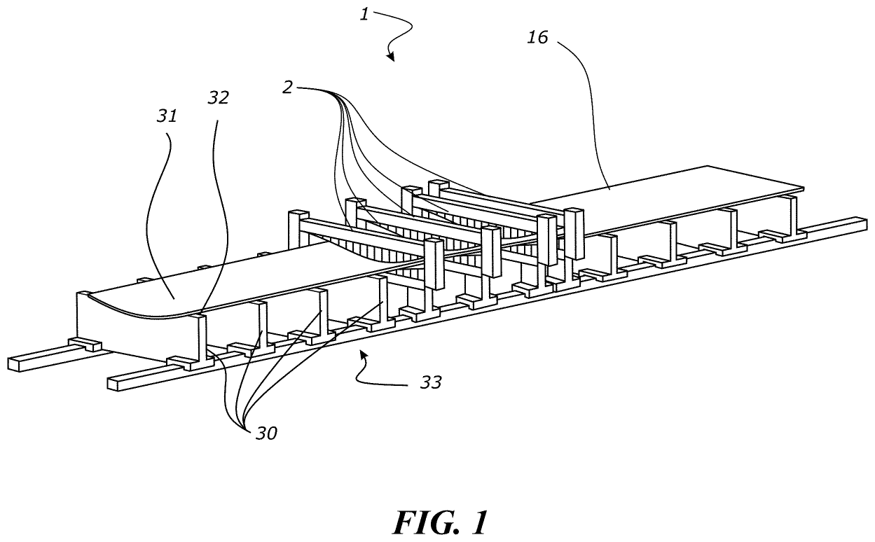

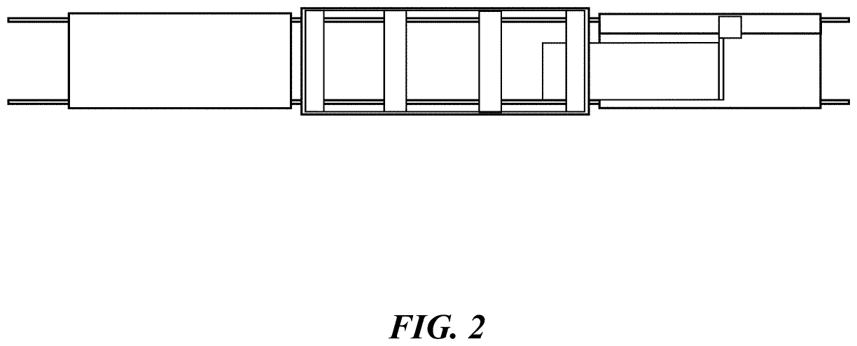

FIG. 1 show an apparatus 1 for forming material. The apparatus 1 may have at least one forming unit 2. The forming unit(s) 2 may have at least one forming opening 3 to receive a feed of material to be formed 16.

At least one of said forming opening(s) 3 may have opposing forming surfaces 4. The forming surfaces 4 may be configured to engage with a surface of the material to be formed to modify the shape or profile of a material to be formed as it passes through the forming opening 3 or the forming unit 2.

At least one of the forming surfaces 4 may be dynamically controllable (for example, by controller 100) into a pre-determined shape or profile to impart a resultant shape or profile of a pre-determined formation upon the feed of material passing through said forming opening of a said forming unit.

In some embodiments, the at least one forming opening 3 is dynamically controllable (for example, by controller 100) into a pre-determined shape or profile to impart a resultant shape or profile of a pre-determined formation upon the feed of material passing through said forming opening of a said forming unit.

In some embodiments, one or more or a pair of opposing forming surfaces are individually and dynamically controllable (for example, by controller 100) into a pre-determined shape or profile to impart a resultant shape or profile of a pre-determined formation upon the feed of material passing through said forming opening 3 of a said forming unit 2.

The apparatus 1 may comprise a material advancer for advancing a feed of material to be formed 16 to, and/or through said opening of a said forming unit.

The material advancer may be configured to advance the material to be formed 16 towards and/or through the at least one forming opening 3 of the at least one forming unit 2, so as to form the material 16 into the pre-determined formation.

The material may be imparted with a pre-determined formation from each said forming unit 2.

As shown in FIG. 1 the material may be sequentially fed through a sequentially arranged series of forming units 2. Each said forming unit 2 may impart the same or a different pre-determined formation to said material.

The material may achieve a resultant formation from a sequential application of forming forces imparted by a sequentially arranged series of said forming units 2.

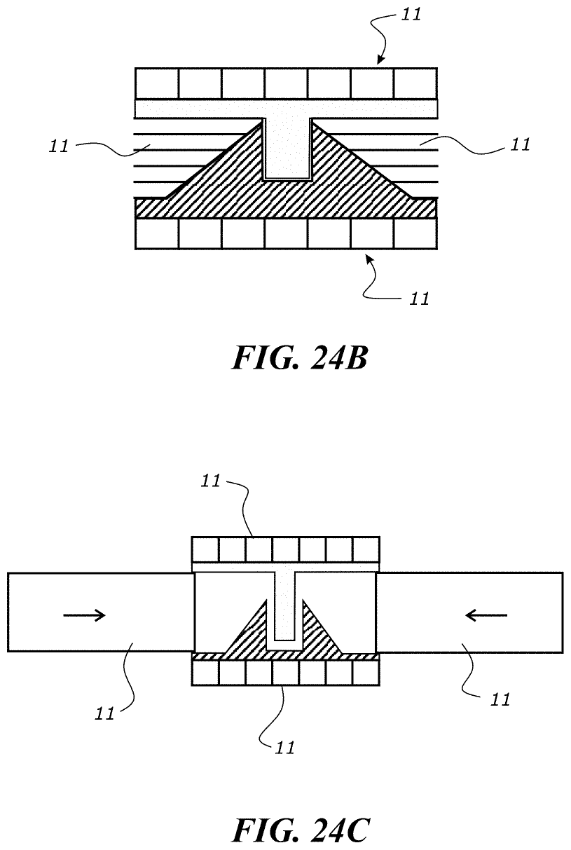

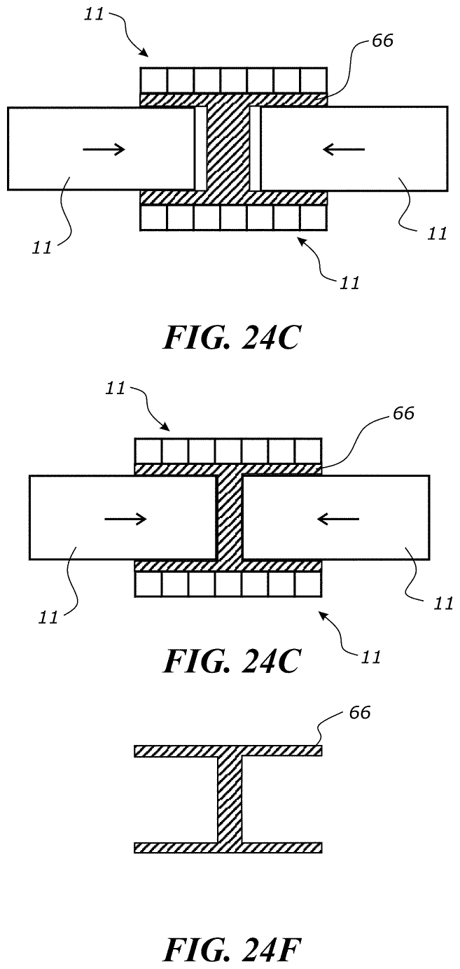

In some embodiments one or more materials may be provided to the forming unit. The one or more materials may be formed into a consolidated material by the forming unit (for example, as shown in FIGS. 24A to 24F).

For example, as shown in FIG. 1 the material passes through each forming opening 3 of each forming unit, and as the material passes through each forming open is formed from a first or inlet shape or profile to a second or outlet shape or profile. The material then passes to a subsequent forming unit 2 where the process is repeated.

The apparatus may comprise a controller 100. The controller 100 may be configured to control aspects of the apparatus 1.

The controller 100 may be configured to modify the cross-sectional shape or area or profile of the forming opening 3 of the forming unit 2. The controller may be configured to modify the cross-sectional shape of the forming opening 3 of the or each forming unit 2 according to a predetermined desired or resultant shape of the material to be formed.

The forming unit 2 and/or the forming opening 3 and/or the forming surfaces 4 may be configured to apply pressure or force to the material to be formed. The forming unit 2 and/or the forming opening 3 and/or the forming surfaces 4 apply pressure to one or more sides of the material to be formed.

In some embodiments the pressure or force changes the profile of the material to be formed as it passes through the forming opening.

In some embodiments, the pressure or force promotes consolidation of the material to be formed.

The forming unit 2 may comprise one or more forming surfaces 4. The forming unit 2 may comprise at least one upper or top forming surface. The forming unit 2 may comprise at least one lower or bottom forming surface. The forming unit 2 may comprise a one or more side forming surface(s).

The forming unit 2 may comprise one or more modules 15, the one or more modules 15 may define a profile or forming surface 8 of the forming opening 3.

The forming unit 2 may comprise an upper or top module 5. The upper or top module 5 may be configured to define an upper or top profile or an upper or top forming surface 8 of the forming opening 3.

The upper or top forming surface 8 may be configured to engage with an upper surface of the material to be formed.

The forming unit 2 may comprise a lower or bottom module 6. The lower or bottom module 6 may be configured to define a lower or bottom profile or a lower or bottom forming surface 9 of the forming opening 3.

The lower or bottom forming surface 9 may be configured to engage with a lower surface of the material to be formed.

The forming unit 2 may comprise one or more side module(s) 7, 7′. The side module(s) 7, 7′ may be configured to define one or more side profiles or one or more side forming surface(s) 10 of the forming opening.

The side forming surface 10 may be configured to engage with a side surface of the material to be formed.

The one or more side modules 7, 7′ comprise a first side module 7 and a second side module 7′. The first side module 7 may be located on a first side of the forming opening 3, and the second side module 7′ may be located on a second side of the forming opening 3.

In some embodiments, the first side module 7 and second side module 7′ are located on opposite sides of the forming opening 3.

In some embodiments, the upper or top module 5 may be a mirror image of the lower or bottom module 6.

The upper or top module 5 and the lower or bottom module 6 are substantially the same width and length.

In some embodiments, a width of the upper or top module 5 and the lower or bottom module 6 may be substantially the same as the material to be formed.

The forming unit 2 may comprises at least one actuator. The at least one actuator 11 may be configured to modify or vary the cross-sectional area of the forming opening.

The at least one actuator may be one or more of:
a robotic end effector, a vacuum actuator, a pneumatic actuator, a muscle actuator, a servo actuator, a hydraulic actuator, a voice coil actuator, a piezo actuator.

In some embodiments the actuator is a linear actuator configured to increase and/or decrease in length.

In some embodiments a surface of the actuator 11, for example an end surface which contacts a surface of the material to be formed may be controllable in profile to provide for a variable profile of the surface.

The at least one actuator may be configured to modify the pre-determined shape or profile of the forming surfaces 4.

A surface of the at least one actuator 11 may be configured to define at least a portion of the forming surface 4.

A surface of the at least one actuator configured to form part of the forming surface 4 may be for example a quadrilateral, or circle or other shape.

The actuators 11 may be arranged in a pattern. In some embodiments the actuators 11 may be arranged in a grid-type pattern.

The forming surface 4 may be continuous or discontinuous.

In some embodiments the forming surface may be provided by a series of adjacent actuators 11.

In some embodiments the actuators 11 may be abutting.

The at least one actuator 11 may be configured to modify the pre-determined shape or profile of the forming surfaces 10.

The at least one actuator 11 may comprise an end cap. The end cap may define the end surface of the actuator 11.

The end cap may be connectable and disconnectable from the at least one actuator. In some embodiments the end cap may be integrally formed with the actuator 11.

The profile or shape of the end cap may dynamically controllable.

The end cap may be connectable to and disconnectable from one or more end cap of an adjacent actuator(s).

Each end cap may comprise a connection feature (for example a channel), the connection feature allowing for connection and disconnection between the end cap of adjacent actuator(s).

A plurality of connected end caps may form said forming surface 10.

The end cap may be of any predetermined shape.

The end cap may comprise one or more of:
a wheel or roller, a point, a ridge, a blade or other cutting tool, a flat surface, a curved surface.

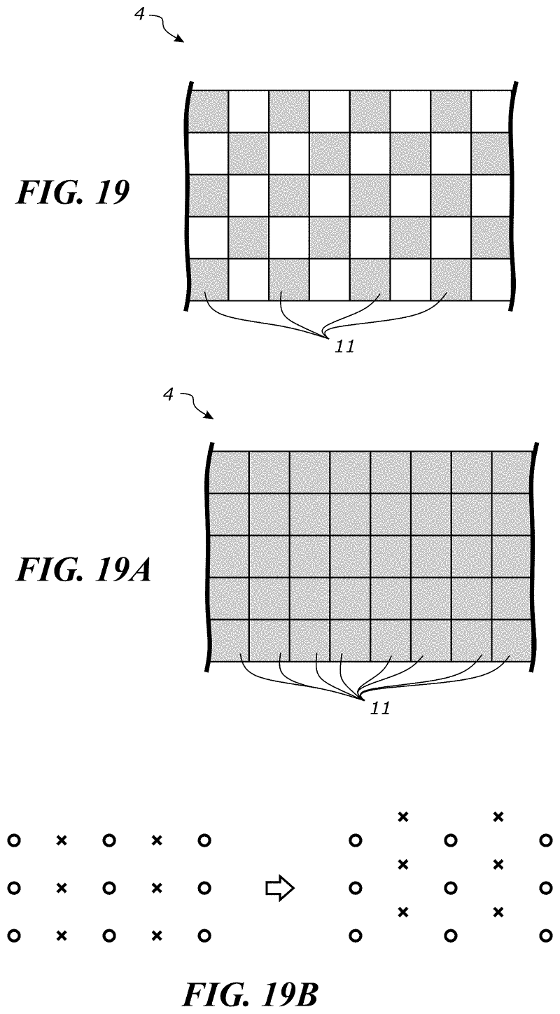

FIGS. 19 and 19A shows a view of a forming surface 4 formed by a grid-like pattern or actuators, where the actuators are arranged in a row and column layout.

It will be appreciated other layouts may be provided.

As shown in FIG. 19A the actuators 11 may form a continuous forming surface. In FIG. 19A each of the cells is occupied by an actuator 11.

As shown in FIG. 19 the actuators 11 may form a discontinuous surface (for example, there may be gaps between the actuators 11). In FIG. 19 each alternating cell is unoccupied by an actuator 11 to provide for a chess board style pattern.

In some embodiments the modules 15 may comprise cooling systems to cool the actuators.

FIG. 7A shows a forming unit 2 comprising a plurality of actuators 11. The actuators 11 may be individually and/or independently controllable by controller 100, to modify the pre-determined shape or profile of the forming surfaces 4. The actuators 11 may vary in length, or change in shape, to change the shape or profile of the forming surface 4. FIG. 7B shows an example of a forming surface 4 modified in shape or profile by actuators 11. The forming surface 4 may then impart such a shape to the material to be formed.

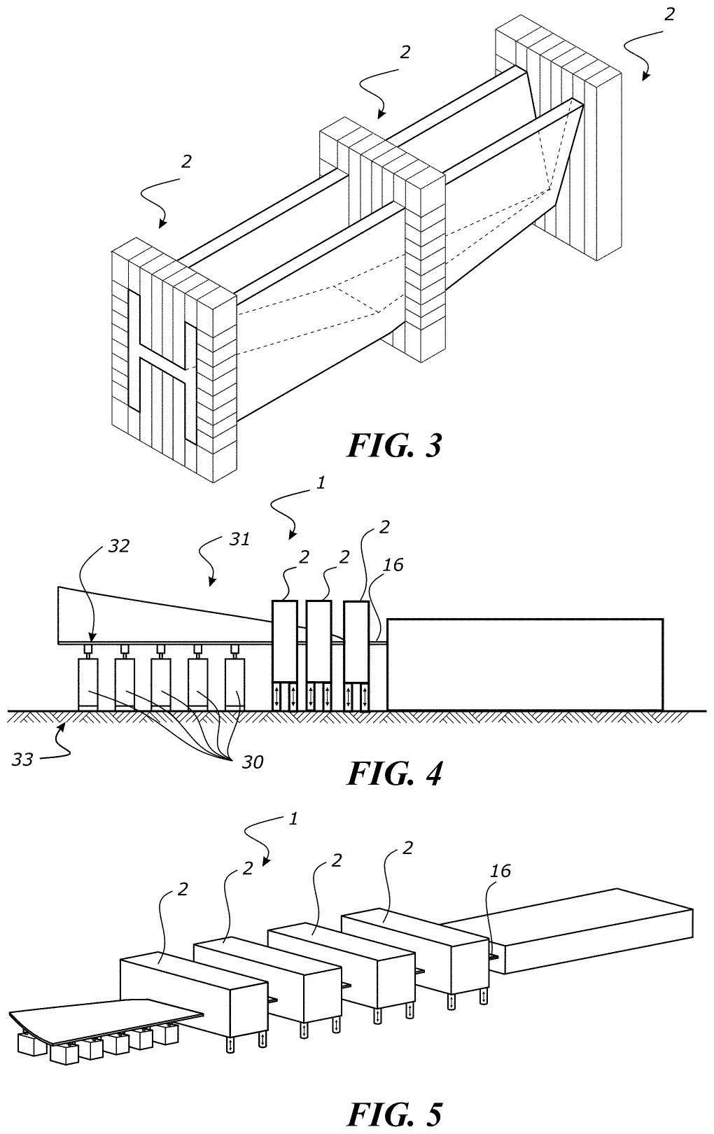

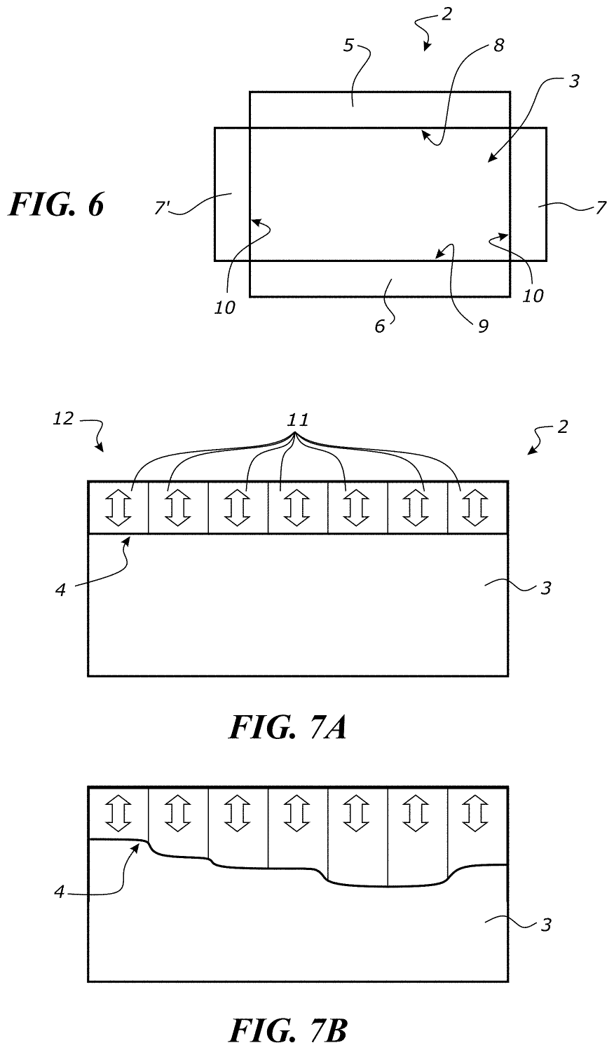

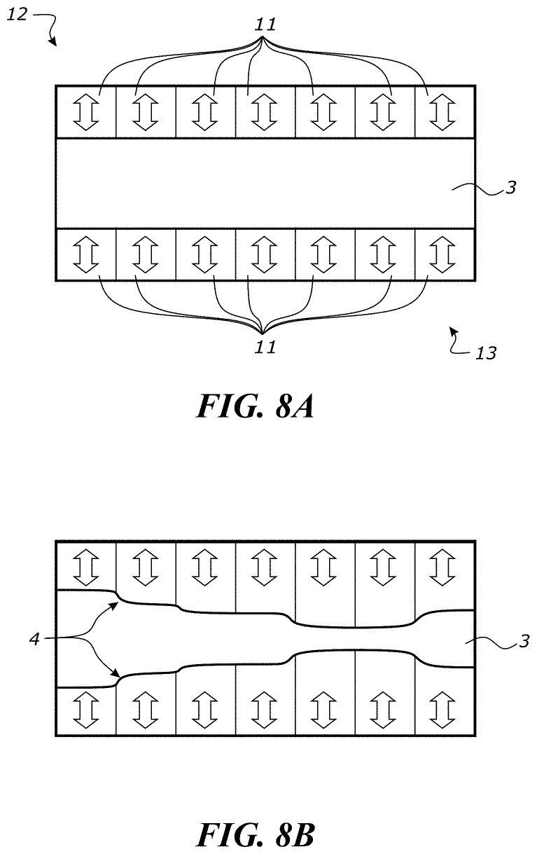

FIG. 3 shows an example of a material being formed to a desired pre-determined shape or profile by forming units 2.

The upper or top module 5 and/or the forming unit 2 may comprise an upper or top actuator module. The upper or top actuator module 12 comprising at least one actuator 11.

The lower or bottom module 6 and/or the forming unit 2 may comprises a lower or bottom actuator module. The lower or bottom actuator module 13 may comprise at least one actuator 11.

The one or more side module(s) 7, 7′ and/or the forming unit 2 may comprise a side actuator module 14. The side actuator module 14 may comprise at least one actuator 11.

The controller 100 may be configured to control the position of at least one actuator 11 to modify or vary the cross-sectional area of the forming opening.

Each module 15 (for example the upper or top module 5, the lower or bottom module 6, and/or the one or more side module(s) 7, 7′) may each comprise sub-controllers which interface and connect with the controller 100.

Each module 15 or actuator module may comprise one or more edge actuators configured to engage one or both edges of the material to be formed. The edge actuators may comprise a pair of opposing edge actuators configured to engage opposing sides of the material to be formed.

Each actuator 11 or a group of actuators, or the actuator module may be configured to be independently controlled.

Each actuator 11 or a group of actuators, or the actuator module may be configured to be moveable. Each actuator 11 or a group of actuators, or the actuator module may be configured to be moveable along a length and/or width of the material.

Each actuator 11 or a group of actuators, or the actuator module is configured to be moveable in a direction along the apparatus, and/or a direction parallel to the apparatus.

Each actuator 11 or a group of actuators, or the actuator module is configured to be moveable by one or more actuators. The actuators may be moveable by one or more gantry systems.

FIGS. 19 and 19B show for example a first group of actuators or second actuator module (indicated by the reference O, or non-shaded area in FIG. 19) and a second group of actuators or second actuator module (indicated by the reference X or the shaded area in FIG. 19).

In some embodiments a first actuator or a first group of actuators, or a first actuator module may be configured to be controlled independently from a second actuator or a second group of actuators, or second actuator module.

In some embodiments the first actuator or the first group of actuators, or the first actuator module is controlled to engage a surface of the material, while the second actuator or the second group of actuators, or the second actuator module is being moved to a desired position. For example, as shown by FIG. 19B where the first group of actuators (indicated by the reference O) engages with the material while the second group of actuators (indicated by the reference X) is configured to move.

In some embodiments the second actuator or the second group of actuators, or the second actuator module is controlled to engage a surface of the material, while the first actuator or the first group of actuators, or the first actuator module is being moved to a desired position.

In some embodiments the system may comprise an alignment system. The alignment system may be configured to align the material to be formed with respect to the forming unit and/or the apparatus.

In some embodiments the system may comprise an advancer system. The advancer is described in more detail below.

In some embodiments the alignment and/or advancer system may be configured to hold the material at or near the edges of the material.

The actuators 11 may be configured to be held in an arrangement by the module. The module 15 may mechanically retain and hold the actuators. The module 15 may provide for an electronic connection between the actuators 11, and/or between the actuators 11 and the controller 100.

In some embodiments the edge actuators and/or advancer may be configured to act as a stretch unit (as described in more detail below).

The modules 15 may be connected to an electrical power source and/or comprise one or more batteries. In some embodiments wireless power transfer may be provided between the modules and an electrical power source.

In some embodiments the module 15 may be provided with a wired or wireless data connection with the apparatus 1, and/or the controller 100.

In some embodiments the actuator(s) 11 may comprise one or more electrical connection features, the electrical connection features configured to provide for an electrical connection between adjacent actuators and/or between the actuator and the module 15.

The actuators 11 may comprise one or more engagement features. The engagement features may allow for engagement with the module 15 and/or an adjacent actuator.

The module 15 and/or each actuator may comprise one or more temperature, voltage, current, force or pressure sensors.

The actuators may be configured to apply pressure via vibrations or micro-vibrations. In an example embodiment, vibrations or micro-vibrations may be controlled by regulating the pressure applied to the actuators or to the material. For example, in a hydraulic or pneumatic system, the hydraulic or pneumatic pressure to the actuator may be increased and decreased in a rapid manner to provide a vibrational effect. Put another way, the stroke of the actuator may be increased and decreased in a rapid fashion to provide vibrations or micro-vibrations.

The use of vibrations or micro-vibrations when forming a material in the examples as described herein may advantageously provide for accurate control of the pressure applied to a material.

The module 15 and/or each actuator may comprise one or more additional sensors to provide an output indicative of consolidation and thermoplastic activation or any other critical data required for quality testing, integrity of process and materials for the determination of material reliability of finished products.

The module 15 and/or each actuator may comprise one or more position sensors. The position sensors may be configured to measure a position of the module and/or the actuator.

In some embodiments the position sensors may work in closed loop control to operate the actuators to a desired location.

The temperature sensor may be configured to measure the temperature of the material to be formed where it contacts the actuator 11 and/or the module 15.

The voltage and current sensor(s) may be configured to measure the voltage supplied to the at least one actuator 11 and/or the module 15.

The force sensor may be configured to measure a force between the actuator 11 to the material to be formed.

The pressure sensor may be configured to measure a vacuum pressure.

The module 15 and/or each actuator may comprise one or more processors and/or memory. The processors and/or memory may be configured to receive input from one or more sensors, and/or to control the operation of the actuator 11 and/or the module 15.

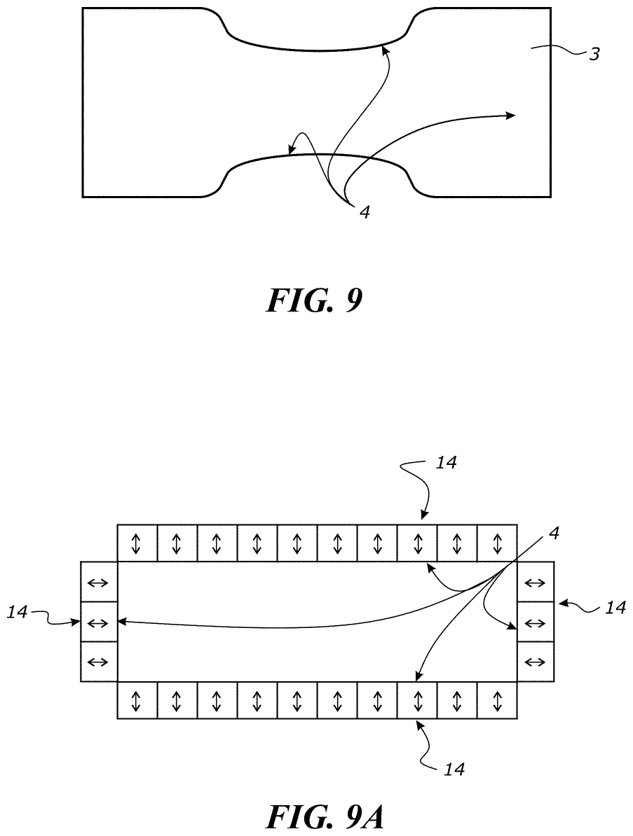

FIG. 9A shows an embodiment of a forming unit 2. The forming unit 2 comprises a series of modules around the perimeter of the forming opening 3. The modules define a series of forming surfaces 4 configured to engage a surface of the material to be formed. The modules 15 allow for modification of the shape or profile of the forming surfaces 4, and the forming opening 3.

FIG. 9A shows an example of a modified forming opening 3 where the modules 15 have acted to change the shape or profile of the forming surfaces 4 and the forming opening 3.

FIGS. 9 and 9A show forming surfaces 4 which are modifiable on each side, or around a complete perimeter of the forming opening. In some embodiments one or more of the forming surfaces may not be modifiable.

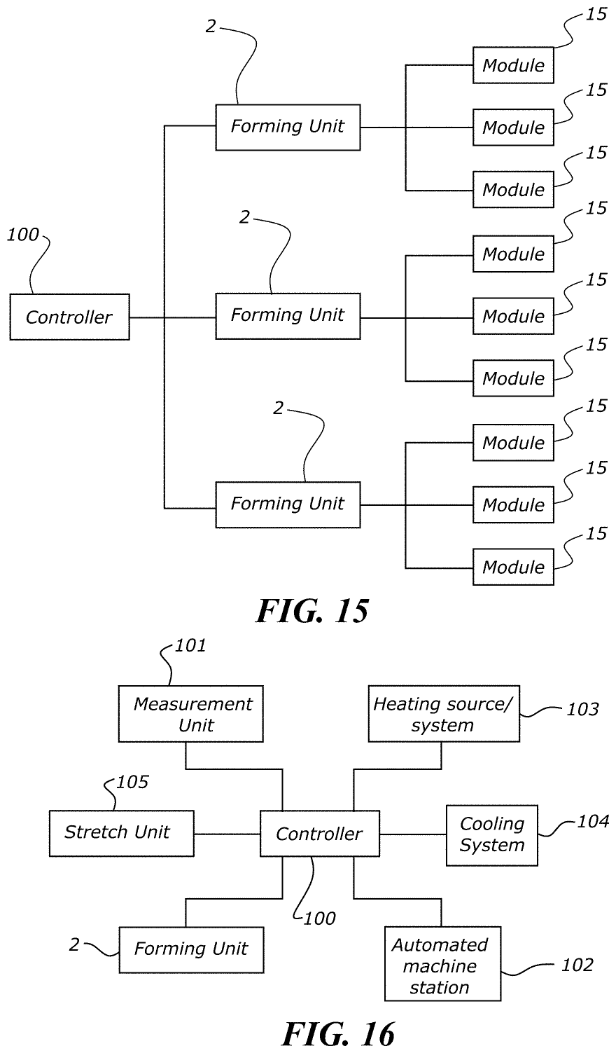

FIG. 15 shows a diagram of the controller 100, forming unit 2 and various modules 15. The controller 100 is configured to connect and interface with each forming unit 2, and each of the modules 15 of each forming unit 2.

Described now is a method of control of the at least one actuator 11.

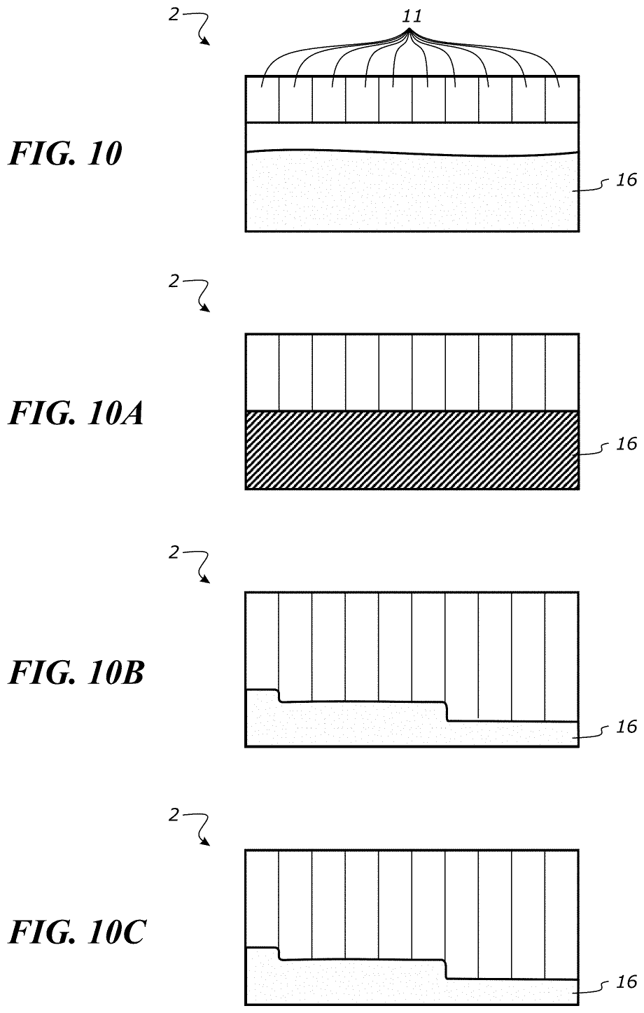

FIG. 10A shows the forming unit 2 where the at least one actuator 11 is located in a relaxed or retracted position.

The at least one actuator 11 may be controlled by the controller 100 to reach a first predetermined location (or a first desired stroke length).

The first predetermined location may correspond to or with a material hold position. Such an example position is shown in FIG. 10A where the actuators 11 have been advanced into contact with a surface of the material to be formed.

The at least one actuator 11 may be controlled by the controller to apply a predetermined forming force to the material to be formed. The location of the at least one actuator 11 may vary during application of the forming force for example in response to consolidation, or forming of the material 16.

In some embodiments the forming force is applied as a forming force profile.

In some embodiments the forming force or forming force profile varies along a length of the material to be formed.

In some embodiments the forming force or forming force profile is based on a characteristic of the material to be formed.

In some embodiments the forming force or forming force profile varies along a length of the material to be formed based on a characteristic of the material to be formed, and/or a desired characteristic of the material as formed.

In some embodiments the forming force or forming force profile is based on the material type of the material to be formed.

In some embodiments the forming force or forming force profile is based on the thickness of the material to be formed.

In some embodiments the forming force or forming force profile may be based on the number of layers of the material to be formed.

In some embodiments the forming force or forming force profile may be based on the presence of a core material in the material to be formed.

The predetermined forming force is applied to the material to be formed by advancing to a second predetermined location (or a second desired stroke length). Such an example position is shown in FIG. 10B where the at least one actuator has been further advanced to apply a force to the upper surface of the material to be formed 16.

The predetermined forming force applied to the material to be formed may be based on an output from a force sensor. The force sensor may be located in one or more modules 15 and/or one or more actuators 11, and/or the forming unit 2.

Alternatively, one or more sensors may be located or embedded into the product. The embedded product sensors may be monitored during and after manufacture of the product (i.e. the any time during product life cycle). Sensors may be passive or active sensors, and may be activated by various sources including scanning devices (for example, RFID) to produce information at a particular point and time in a product life cycle, either during manufacture or use of said product. For example, sensors may be used to record manufacturing data to create a unique product ID and to measure product performance during product life cycle.

The embedded sensors may be one or more of a strain sensor, a stress sensor, a temperature sensor, a pressure sensor, a force sensor, a light sensor, a UV sensor, or other sensors applicable to product manufacture and life cycle. For example, to ensure replacement before product failure, or to provide feedback to a manufacturing process as described herein.

The controller may be configured to control the at least one actuator 11 to apply said predetermined forming force for a predetermined time.

The at least one actuator 11 may be controlled by the controller to reach a third predetermined location (or a third desired stroke length).

The third predetermined location may correspond to or with a material hold position. Such an example position is shown in FIG. 10B where the at least one actuator has been unloaded so as to not apply the forming force to the upper surface of the material to be formed 16. Depending on material properties this may allow the material 16 to slightly spring back for example in the direction shown in FIG. 10C.

The controller 100 may be configured to control the at least one actuator 11 in accordance with an actuator control scheme.

The actuator control scheme may be to:

i. move to said, first predetermined location,

ii. apply said predetermined forming force for said predetermined amount of time,

iii. move to said third predetermined location.

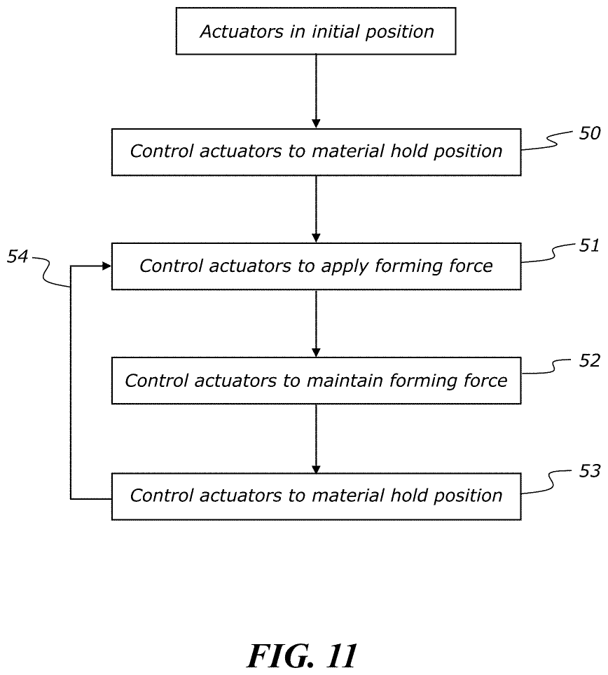

As shown in FIG. 11 the actuator control scheme may be to, one or more of:

i. control the actuators to a material hold position 50,

ii. control the actuators to apply the forming force 51,

iii. control the actuators maintain said forming force 52 for a predetermined amount of time,

iv. control the actuators to a material hold position 53.

The actuator control scheme may be undertaken continuously and/or sequentially.

In some embodiments the application, maintenance and release (for example steps 51, 52 and 53) may be undertaken one or more times as a forming cycle 54. In some embodiments said forming force may be different for each forming cycle 54. In some embodiments a plurality of forming cycles 54 may be undertaken.

By applying a force, holding and releasing the force (as a forming cycle) then reapplying at varying levels of forming force, the material will yield a superior surface finish and promote consolidation of the material.

In some embodiments the forming force is increased for each forming cycle.

The material 16 may be advanced between each actuator control scheme.

In some embodiments, one or more of:

the first predetermined location, a predetermined forming force (or the second predetermined location), the third predetermined location, may be controlled to be varied for each actuator control scheme.

The controller is configured to determine said actuator control scheme, in accordance with the profile of the material as formed, or the material to be formed.

In some embodiments the actuators 11 may be configured to engage a surface of the material substantially concurrently, so as to apply said forming force concurrently. The concurrent application in force across the width of the material may prevent the application of a localised force.

In some embodiments, the system or forming unit may comprise one or more actuators as a detail actuator. The one or more detail actuators may comprise have a pre-determined end shape configured to engage with a surface of the material. The pre-determined end shape may be provided, for example, by an end cap as described above. The detail actuators may be configured to be controllable to engage with the surface of the material to be formed. For example, the detail actuator may be a point or fine tip and be configured to form a valley in a surface of the material to be formed.

The movement of the detail actuator may be controlled to by the one or more controllers 100.

In some embodiments the detail actuator may be moveable along the width and/or length of the material to be formed.

One or more actuators 11 may be provided as hold actuators to retain the material to be formed while the detail actuator is engaged with a surface of the material.

In some embodiments the detail actuator may act as a machine tool or CNC tool (as described herein).

The detail actuator may be an actuator as described above, or a separate actuator.

In some embodiments, the at least one actuator 11 comprise at least one swivelling portion. The at least one swivelling portion may be configured to be moveable in at least one degree of freedom, or one degree of freedom, or two degrees of freedom, or three degrees of freedom, or four degrees of freedom, or five degrees of freedom, or six degrees of freedom, or at least six degrees of freedom.

In some embodiments the swivelling portion may enable adjustment of the angle swivelling portion relative to the actuator 11. In some embodiments the swivelling portion may comprise a positioning spring configured to enable adjustment of the angle swivelling portion relative to the actuator 11.

The swivelling portion may be located at an end and/or a base of said at least one actuator.

The swivelling portion may be actuated or moved by one or more further actuators, or motors. The one or more further actuators, or motors may be controllable by the controller 100 to orient the swivelling portion relative to one or more of the actuator 11 to which it is attached and/or the forming opening 3.

The at least one swivelling portion may comprises a resilient membrane 20.

A heat protection layer, or heat shield is provided over and/or under the resilient membrane 20. The heat protection layer, or heat shield may be provided between the resilient membrane 20 and the material to be formed, and/or between the resilient membrane 20 and the forming surface 4.

The heat protection layer, or heat shield may comprise a metal foil layer, a ceramic layer, or a carbon or fiberglass nano tube structure.

The heat protection layer or heat shield may be substantially flexible.

In heat protection layer or heat shield may be made of any suitable material which can withstand the temperature of the material to be formed.

The heat protection layer, or heat shield may mitigate or prevent heat transfer from the material to be formed.

heat protection layer, or heat shield may be configured to be useable for example at temperatures of 200 to 450 degrees Celsius or up to or exceeding 800° C. (degree Celsius).

In some embodiments there may be a plurality of actuators, and each actuator may have an associated swivelling portion.

The swivelling portion may be located at or near an end of the actuator 11 which is configured to engage a surface of the material to be formed 16. The swivelling portion may be configured to form at least part of, or the entire forming surface 4, configured to engage the surface of the material to be formed 16. For example, the actuators as shown in FIGS. 7A and 7B may have an associated swivelling portion located at an end of the actuator 11 which is configured to engage a surface of the material to be formed 16.

In some embodiments each actuator 11 and/or the forming surface 4 may be provided with a releasing agent. The releasing agent may be configured to allow for release of the actuator and/or the forming surface from the resilient membrane 20 and/or material to be formed 16. In some embodiments the releasing agent may be a liquid spray.

The resilient membrane 20 may be connectable and disconnectable from said swivelling portion.

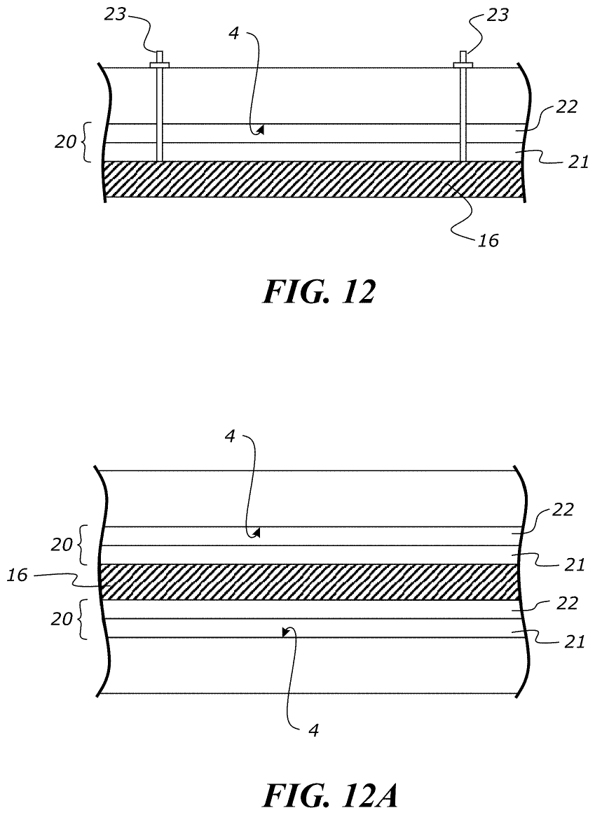

As shown in FIG. 12 the forming apparatus may comprise at least one resilient membrane 20. The resilient membrane 20 may be located between a forming surface 4, (for example, a surface of the swivelling portion and/or at least one actuator 11, and/or module 15) and a surface of the material to be formed 16.

In some embodiments the actuators are provided at a spacing such that a resilient membrane 20 may not be required or provided.

The at least one resilient membrane 20 may be provided with at least one release film 21 and/or at least one release fabric configured to contact a surface of the material to be formed 16.

The at least one release film 21 and/or the at least one release fabric may be configured to allow for the removal and/or release of the resilient membrane 20 from the material to be formed 16.

The at least one resilient membrane 20 may be provided with a heat protection layer 22, or heat shield.

The heat protection layer 22, or heat shield may comprise a metal foil layer, or a ceramic layer.

The heat protection layer or heat shield may be substantially flexible.

In heat protection layer or heat shield may be made of any suitable material which can withstand the temperature of the material to be formed.

As shown in FIG. 12A the resilient membrane 20 may comprise an upper resilient membrane and a lower resilient membrane.

The upper resilient membrane and the lower resilient membrane may form an enclosed resilient membrane. The upper resilient membrane and the lower resilient membrane may be joined at or along least one edge.

The resilient membrane 20 may comprise one or more side resilient membranes, the side resilient membranes may be joined to one or more of the upper resilient membrane and the lower resilient membrane at or along at least one edge.

The resilient membrane 20 may be formed over one or more forming surfaces 4. In some embodiments the resilient membrane 20 may be formed over one or more actuators 11, or said associated swivelling portions. The resilient membrane 20 may define a surface for contact with the material to be formed 16.

The resilient membrane 20 may overlay the at least one forming surface 4 (for example the plurality of actuators or said associated swivelling portions.)

The lower or bottom module 6, and/or the lower or bottom forming surface 9 may comprises a lower or bottom resilient membrane.

The lower or bottom resilient membrane may define a lower surface of the forming opening 3.

The side module 7, 7′ and/or the side forming surface 10 may comprise a side resilient membrane.

The side resilient membrane may define a side surface of the forming opening 3.

The or an upper or top module 5 and/or the upper or top forming surface 8 may comprise an upper or top resilient membrane.

The upper or top resilient membrane may define an upper or top surface of the forming opening 3.

In some embodiments a vacuum may be created between the resilient membrane 20 and a surface of the material to be formed 16.

The vacuum may be created by for example a vacuum pump.

The resilient membrane may be provided with at least one vacuum port 23. The vacuum port 23 may comprise at least one one-way valve. The vacuum port may allow for any gases located between the resilient membrane 20 and the material to be formed 16 to be removed. This allows for the resilient membrane 20 to engage with a surface of the material to be formed 16. The vacuum generated may also act to help the resilient membrane 20 conform to the surface of the material to be formed 16 as it changes shape or profile during the forming process.

The vacuum port may be located outside a boundary of the material to be formed. Such an example configuration is shown FIG. 14 where the resilient membrane 20 extends laterally beyond the edge of the material to be formed 16. The vacuum ports 23 are then located outside the forming area.

The forming apparatus 1 may comprise one or more rollers configured create said vacuum.

The vacuum generated may also promote consolidation of the material to be formed 16.

The resilient membrane 20 may be configured to remain in contact with a surface of the material to be formed 16. In some embodiments, during forming, the vacuum may be maintained so the resilient membrane 20 conforms with the surface of the material to be formed.

The vacuum may be formed between the resilient membrane and the material to be formed 16, and when the actuators are retracted, the vacuum formed may maintain the resilient membrane 20 in contact with a surface of the material to be formed 16.

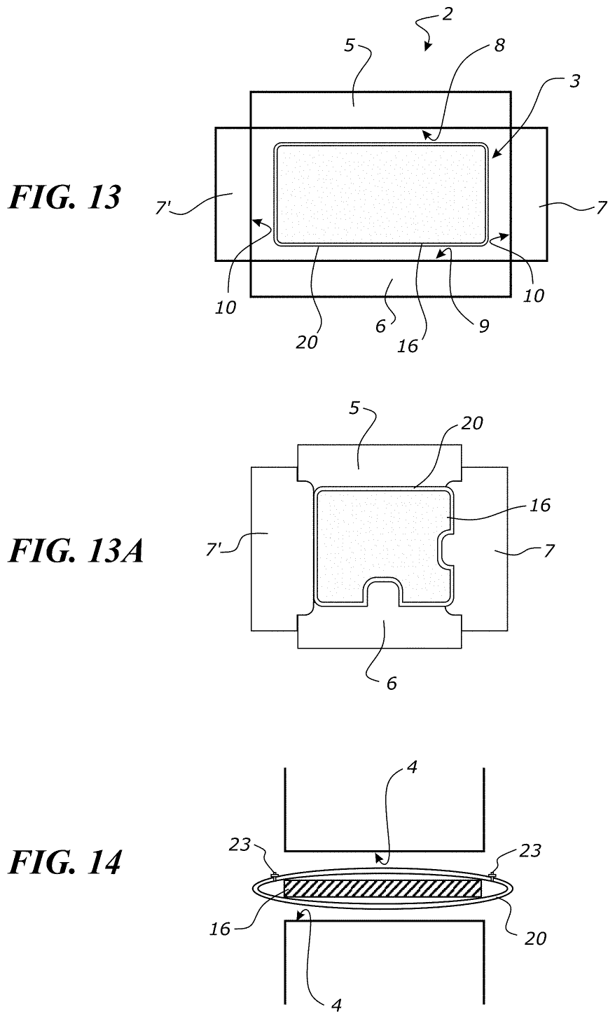

FIGS. 13 and 13A shown an example of a resilient membrane 20 applied to the external surface of a material to be formed 16. In FIG. 13 the forming unit is in an initial position where the modules 15 are not engaged with a surface of the resilient membrane 20. In FIG. 13 the modules 15 have been moved into engagement with a surface of the resilient membrane 20 to form the material 16.

The forming apparatus and/or at least one forming unit 2 may comprises one or more heat source(s) or heating system 103.

The one or more heat source(s) or heating systems 103 may comprise one or more of:
a microwave heating source, an infrared source, electrical heater or electrical heating device, gas heating (for example natural gas), air heating (for example heating a body of air or other gases and then using them to provide heat), induction heating, electromagnetic induction heating.

Any of the heating steps or processes as described herein may be carried out using induction heating. Induction heating technology may advantageously provide for very quick heat ramps or increases in temperature. Additionally, induction heating may be combined with vacuum processing.

In an example embodiment, induction heating, vacuum, and performance cooling (for example with turbulent water flows) may be used to advantageously provide a controllable and accurate temperature control during processing.

Advantageously, induction heating may provide for lowering energy consumption and limiting secondary operations. Induction heating may advantageously provide very high temperature limits and may be adaptive to high temperature homogeneity and multi-zone heating.

In an example embodiment, flexible inductors may be provided that are incorporated or embedded in a membrane or product, and can therefore follow any complex shape required whilst providing targeted heating.

A high frequency current may be generated to run through the embedded inductors, creating eddy currents and joule effects to heat up the material surface.

Additionally, or alternatively, the use of a vacuum supported by the flexible membrane may enable the removal of residual air and reduce void space within any material layup.

In an example embodiment, the flexible membrane may incorporate cooling channels with water or alternative cooling liquid or fluid to cool the form or product. For example, a cooling regime may be implemented in keeping with the material cooling and crystallization properties to accurately and efficiently cool the form or product. Turbulent water flows may be provided by cooling channels and baffles formed or provided in or on the product to accurately control cooling.

The above-mentioned induction heating, vacuum and cooling properties may provide for high performance for composite parts or products, and allow complex geometries to be formed. For example, low void content and high consolidation levels of material. Additionally, net shape products including structural details are capable of consolidation in conjunction with shape formation systems as described herein.

One or more forming unit 2 may comprise one or more temperature sensors configured to monitor the temperature of a surface, and/or a core of the material to be formed.

In some embodiments the infrared temperature sensor may be configured to measure the core and surface temperature of the material to be formed based on different wavelengths of Infrared radiation.

One or more forming units 2 may comprise one or more sensors. The one or more sensors may include a position sensor.

The apparatus may be divided into a series of zones. The zones may be a lengthwise portion of the apparatus 1. Each zone may comprise at least one energy or heat source(s) 103 or heating system and at least one temperature sensor configured to monitor the temperature of a surface, and/or a core of the material to be formed.

The controller 100 may be configured to receive a signal from said one or more temperature sensors indicative of the temperature of the material to be formed, (for example, the temperature of a surface, and/or a core of the material to be formed) and based on the signal control the power provided to the heat source(s) or heating system 103. The temperature sensors may interface with the measurement module 101.

The temperature sensor may be one or more of:
an infrared temperature sensor, an optical temperature sensor, a microwave measuring system, an electromagnetic radiation measuring system.

The controller 100 may control the power provided to the heat source(s) or heating system(s) 103 based on a difference between the signal received from said one or more temperature sensors indicative of the temperature of the material to be formed (for example the temperature of a surface, and/or a core of the material to be formed) and a desired temperature.

The heat source or heating system 103 may be located in one or more of:
the upper or top module, and/or the upper or top forming surface,
the lower or bottom module, and/or the lower or bottom forming surface,
the side module(s), and/or the side forming surface,
a or the zone of said apparatus 2 (for example said zone being a lengthwise portion of the apparatus).

In some embodiments there may be a plurality of forming units 2. For example, FIG. 1 shows a forming apparatus comprising a plurality of forming units 2.

The plurality of forming units 2 may be arranged in series, such that the material to be formed 16 passes through a first forming unit, and to subsequent further forming units. FIG. 1 shows an example of such a forming apparatus where the material to be formed 16 passes through a series of forming units 2 to be formed.

The plurality of forming units 2 may be configured to gradually change the profile of the material 16 gradually as the material is passed through each of said plurality of forming units 2. In this way the material may gradually and in a stepwise manner be formed as it passes through a series of forming units 2.

The material to be formed 16 may be of a first or initial profile. Each forming unit 2 may be configured to form the material to a corresponding intermediate profile. The final forming unit of the plurality of forming units 2 may be configured to form the material to a final profile.

In some embodiments the forming opening 3 of a penultimate forming unit may have the same shape as the forming opening of a final forming unit.

A forming unit of said at least one forming unit 2 may be configured to transfer said material to be formed to an adjacent forming unit of said at least one forming unit 2. This may allow for the material to be passed or advanced between adjacent forming units 2.

The forming unit may be configured to transfer the material to be formed by moving from a first location towards a second location, the second location being adjacent forming unit so as to provide the material to be formed to the adjacent forming unit and/or advance the material to be formed.

On transfer from a forming unit of said at least one forming unit 2 to an adjacent forming unit, the adjacent unit may be configured to engage the material to be formed 16. After the engagement between the adjacent forming unit 2 and the material to be formed 16 has been created an engagement between the forming unit of said at least one forming unit 2 and the material to be formed 16 may be released.

The engagement between the forming unit of said at least one forming unit 2, and the material to be formed 16, and/or the adjacent forming unit and the material to be formed 16 may be a vacuum or a negative pressure device.

The engagement between the forming unit of said at least one forming unit 2, and the material to be formed 16, and/or the adjacent forming unit and the material to be formed 16, may be the engagement of one or more actuators 11 and/or modules 15.

Subsequent to transfer of the material to be formed from the forming unit of said at least one forming unit 2, the forming unit may be configured to move from the second location towards the first location.

In some embodiments each forming unit is configured to the transfer of said material to be formed an adjacent forming unit in a staggered manner.

The forming opening is configured to be modifiable to vary the location and/or orientation of the forming opening relative to the material to be formed as it is advanced.

In some embodiments each, or a group of said at least one forming units is supported by a forming unit support. The forming unit support may comprise at least one plate.

As shown in FIGS. 4 and 5, the at least one forming unit 2, or the forming unit support may be connected to, or carried by at least one robotic arm. The forming unit 2 or the forming unit support may be connected to the robotic arm via an robot end effector.

The at least one forming unit 2, or forming unit support may be moved by said robotic arm.

The least one forming unit 2 may be actuated by at least one actuator 26. The at least one actuator 26 may be configured to adjust the location of the forming opening 3 and the forming unit 2 relative to the material to be formed 16.

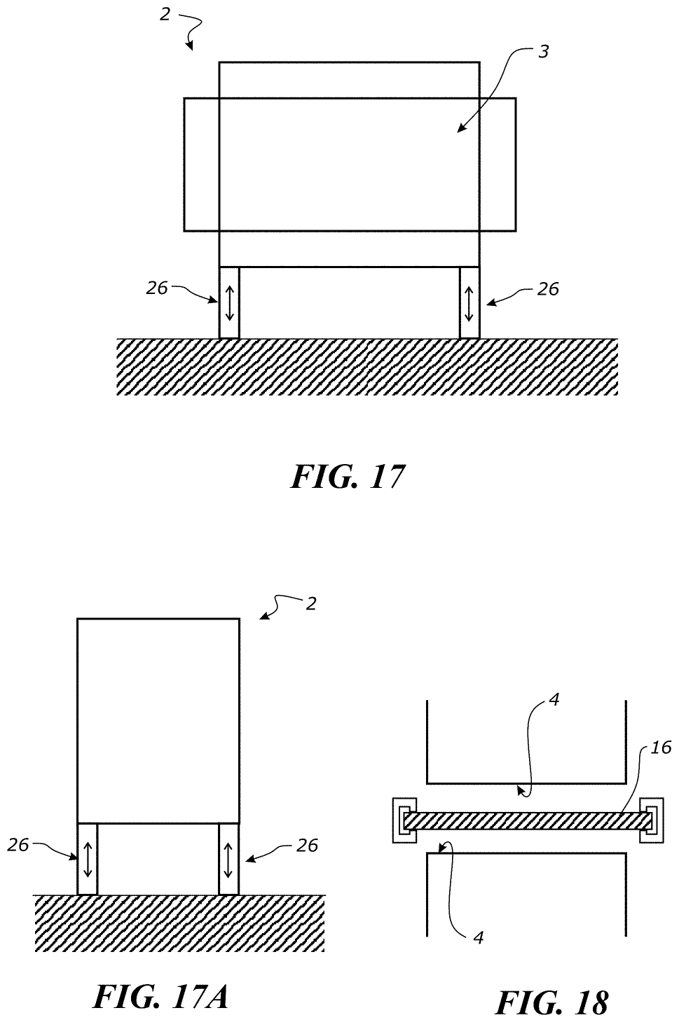

FIG. 17 shows an embodiment of a forming unit 2 having one or more actuators 26 configured to adjust the location of the forming opening 3 and the forming unit 2 relative to the material to be formed 16.

FIG. 17A shows a side view of the forming unit 2 of FIG. 17 where further actuators 26 are shown.

The four actuators 26 of the embodiment of FIGS. 17 and 17A allow for movement of the forming unit 2 in multiple degrees of freedom.

The at least one actuator 26 may comprise one or more of:
a vertical actuator configured to vertically modify the location of the forming unit 2 and/or forming opening 3 relative to a vertical reference plane (i.e. a plane perpendicular to a ground plane),
a horizontal actuator configured to horizontally modify the location of the forming unit 2 and/or forming opening 3 relative to a horizontal reference plane (i.e. a plane parallel to a ground plane),
a tilt actuator configured to tilt the forming unit 2 and/or forming opening 3 relative to a reference plane (i.e. a ground plane).

The at least one forming unit 2 may be configured to actuated by said at least one actuator 26 over a predetermined path. In some embodiments the at least one forming unit 2 may be configured to actuated by said at least one actuator 26 over a predetermined path by the controller 100.

The actuation of the or each forming unit 2 may be configured to create a varying shape or profile of the material to be formed 16. The actuation of the or each forming unit 2 may be configured to create a varying shape or profile of the material to be formed along a length of the material.

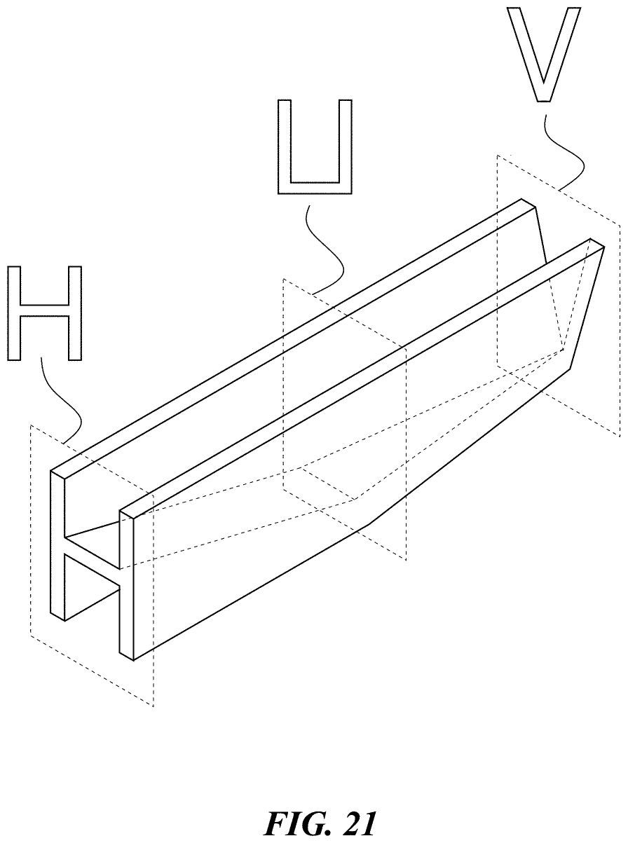

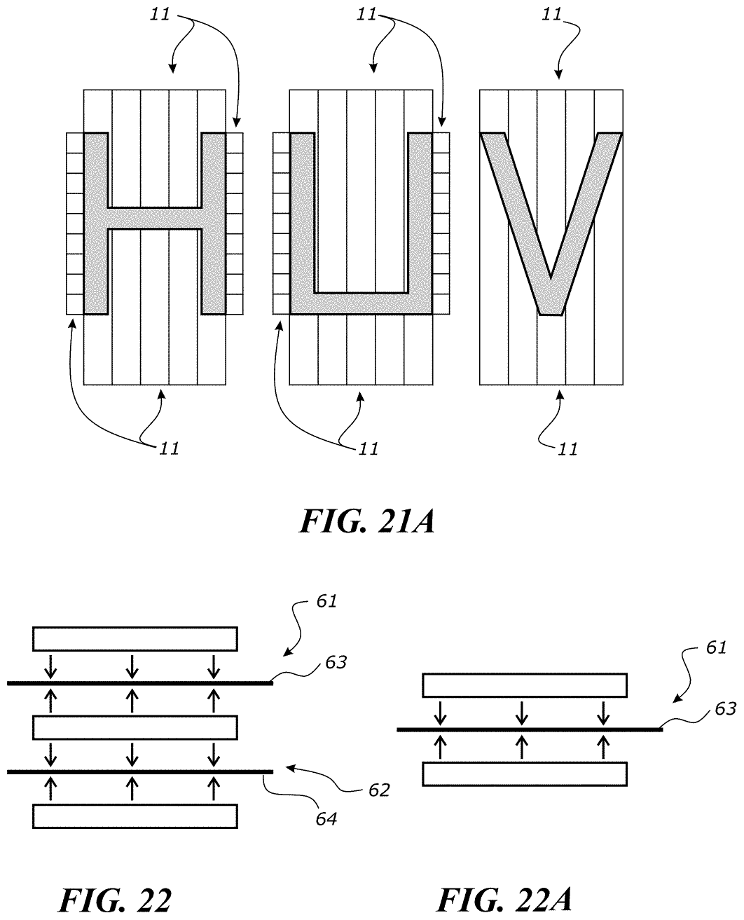

FIG. 21 shows an example of a cross of a formed material created by the forming apparatus. FIG. 3 shows an example of the cross section of FIG. 21 being formed by a series of forming units 2.

The cross-section or profile of the material at a first location or first end of the material is a first profile having an ‘H’ shape. The material then transitions to a second profile at a second location having a ‘U’ shape, and then finally to a third profile having a ‘V’ shape at a third location or second end.

The profile of the material of FIG. 21 would not be possible by a traditional extrusion tool, as the profile changes along the length of the material. Further, to create such a profile from a mould would be difficult.

FIG. 21A shows examples of the actuator locations for the various profiles of the material of FIG. 21A. It will be appreciated that intermediate forming opening shapes will be required as the profile changes along the length of the material.

A velocity of the at least one forming unit along said predetermined path may be based on one or more of:
the speed at which the apparatus advances the material to be formed,
the speed at which the material to be formed is provided to the apparatus,
the temperature of a part of the material to be formed (for example, a core temperature or a surface temperature),
at least one output of the or a measurement module 101.

The material may be advanced at a continuous rate.

The material may advance at about 3 metres/minute.

In some embodiments the speed the material is advanced is based on the material type of the material to be formed.

In some embodiments the speed the material is advanced may be lower or reduced for materials that require crystallisation (i.e. Polyether ether ketone (PEEK)), and be higher or increased for materials that do not require crystallisation (i.e. Polyphenylene sulphide (PPS)).

Wherein the rate at which the material is advanced is based on one or more of:

actuator speed (for example the speed at which the actuators can proceed through an actuator control scheme either as a maximum speed or a controlled speed),

the number of actuators (for example the number of actuators which form a forming surface),

an amount of heat supplied, or able to be supplied by the heating source

a vacuum supplied, or able to be supplied by the vacuum source.

One or more forming units at the end of the plurality of forming units 2 may be configured to be moved by said actuator 26 to shape a final profile of the material to be formed 16.

The movement of said one or more forming units at the end of the plurality of forming units 2 may be controlled by said actuator 26 to provide for one or more of:
a substantially continuously curved profile,
a substantially concave or convex profile,
a profile comprising a curved portion (for example a compound curve),
a profile comprising at least one substantially straight portion.

The forming apparatus 2 may be configured to form the material to be formed 16 into a plurality of portions, each of the plurality of portions having an associated profile or cross-section.

The profile of the material to be formed may be provided to the controller in a suitable manner as is known in the art for example as a 3D model or design.

The associated profile or cross-section of each of the plurality of portions may be different. The associated profile or cross-section of each of the plurality of portions may be different to at least one other of the plurality of portions.

The forming apparatus 1 may be configured to form the material to be formed 16 into at least a first portion having a first profile, a second portion having a second profile, and a third portion having a third portion.

The first profile, the second profile and the third profile may be different.

The forming apparatus 1 may be configured to form the material to be formed 16 into at least a subsequent portion having an associated subsequent profile.

The forming apparatus 1 may comprise an automated machine tool station 102 configured to trim, and or cut and or drill apertures in the material as formed.

The automated machine tool station 102 may be controllable by the controller 100.

The automated machine tool station 102 may be located after the forming units 2, or may be located in line with the forming units 2.

The automated machine tool station 102 may comprise a Computer numerical control (CNC) machine.

The automated machine tool station 102 may comprise a laser or water cutting system.

The forming apparatus may be provided with one or more advancers. The advancers may be configured to advance the material through the machine, and one or more forming units 2. The advancer may be one or more of:
a roller, or an intelligent roller system,
one or more conveyers. The conveyers may be located before, after or between forming units
the movement of the plurality of forming units 2 (as described in more detail above)
at least one fastening device.

The at least one fastening device may be one or more of: a clamp or brace or the or a stretch unit configured to apply tension to the material to be formed.

The fastening device may be configured to fasten with or to the material to be formed 16 and advance to advance the material to be formed.

In some embodiments, the one or more actuators, and/or one or more forming units are or comprise a roller or set of rollers.

The apparatus 1 may further comprise at least one measurement module 101. The measurement module 101 may measure characteristics of the material to be formed 16 during forming, and/or the material as formed. The measurement module 101 may also measure various characteristics of the forming apparatus 1 when in use.

In some embodiments, the apparatus may comprise at least one cooling system 104. The cooling system 104 may be configured to cool the material.

The cooling system may be required where the material to be formed is a composite metal.

The cooling system 104 may be located in-line with the forming units 2, or before or after the forming units.

The cooling system may be configured to cool the material once it passes through said at least one forming unit 2.

The controller 100 is configured to control the at least one cooling system to cool the material in accordance with a cooling profile.

The controller 100 may be configured to control the at least one cooling system to control the removal of heat from the material to be formed 16 or as formed.

The controller 100 may be configured to control the at least one cooling system based on an output of the measurement module 101 (for example a temperature).

The at least one cooling system 104 may comprise one or more of:
air cooling, water or liquid cooling, a water or liquid jacket, nitrogen cooling, ice cooling.

The at least one cooling system 100 may be provided to the resilient membrane 20. The at least one cooling system 100 may be provided to the resilient membrane 20 by at least one roller system.

In some embodiments, the apparatus 1 may be provided with a measurement module or system 101. The measurement module 101 may comprise one or more sensors configured measure variables associated with the forming apparatus 1.

The measurement module 101 may comprise at least one laser measurement system, or computer vision or robotically observable measurement.

In example embodiments, vision systems may be incorporated into the apparatus as described herein. Vision systems may advantageously provide for remote controllability of the apparatus or parts of said apparatus, and may allow the replacement of sensors in the apparatus or product.

In an example embodiment, an optical measurement system, such as a laser measurement system, and a computer vision system may be incorporated into the apparatus as described herein. Additionally, a machine learning software and system may be implemented alongside the computer vision and optical measurement system.

In an example embodiment, the vision system may scan each material layer or product with very high resolution, for example on the micrometre scale. If discrepancies are detected between the actual material layer profile and the designed or intended profile (for example a comparison to a CAD geometry), the system may be configured to compensate and correct the discrepancy further along the process, for example at the next module station. Advantageously, this provides real time or almost real time feedback benefits to provide accurate material processing. Advantageously, the vision system scanner process may be contactless, and therefore may not impart an effect to the material layer being formed.

In an example embodiment, a scanner may scan material layers or the material profile at each module station, and adapt the next layers or profile or module station to achieve a desired geometry of the material layers or the material profile. This may provide advantages over a prior art system where every material layer is formed flat.

The use of a vision system as described herein may advantageously provide for use of a wider variety of materials. For example, taken alone or in combination with an AI and closed loop feedback system, the vision system as described herein may facilitate the identification of random and predictable errors, as described in more detail below. This may facilitate a wider range of material choice, and may allow the use of materials with predicted and optimised properties based on the systems described herein, rather than a traditional system where complex material trials may be employed to optimise material properties.

In an example embodiment, the vision system may allow for in-process quality control, optionally in combination with a machine learning system. With acquired data machine learning, a machine learning algorithm may learn the properties of each material to anticipate said materials behaviour in the system. For example, if a material shrinks, the systems may learn to compensate. In an example, the system may be configured to identify errors and classify the errors into two categories: random errors and repeatable errors. The first category may include issues such as actuator placement and control, while the second category may include problems like material shrinkage. In an example embodiment, a closed feedback loop can address random errors, and machine learning may be used for repeatable errors.

In an example embodiment, the system may provide an initial prediction of the geometry of a final object form based on initial information, such as CAD data. Alternatively, or in addition, the system may scan a final object form and attempt to determine what the initial information contained, for example what an initial CAD model resembled. These two methods may be trained or provided with information in tandem.

In an example embodiment, calibration target object may be used to train the systems described herein, and may be designed with different types of features.

For example, to teach the system about various material properties, a set of calibration parts may be formed using each material. The software and systems may then learn the characteristics such as material flow, misguided calibration and dimensional discrepancies.

With the two technologies described herein, i.e. the machine learning and machine vision with built-in feedback loop, compensation for systematic and random errors may be possible.

The vision system as described herein may enable multi-material capabilities, for example the production of coloured parts with functionally graded materials.

The vision system as described herein may integrate external parts into 3D components. To achieve this, systems can be paused so that an item or external part, such as metal reinforcement or electronics, can be inserted or incorporated into the component during forming. The system may then see the object and incorporate the external part into the 3D product as per design drawings.

The measurement module or system 101 may be configured to measure one or more of the following characteristics:
fibre orientation or fibre alignment, weave orientation or weave alignment, material or matrix thickness, material width, material length, material cross-sectional profile, material side profile, fibre or material quality, material surface temperature (optionally a lower surface, and/or an upper surface of the material), material core temperature, a pressure applied to the material to be formed (optionally by the forming unit, and/or by said vacuum), a tension applied to the material to be formed (optionally by the forming unit and/or the stretch unit), material compression or material crystallisation, any air pockets or voids in the material, stretch or material strength.

The controller 100 may be configured to dynamically vary outputs of the system in response to inputs from the measurement system or module 101. The controller 100 may vary outputs by closed loop control based on inputs from the measurement system or module 101 to control the system to a desired characteristic of the material to be formed or as formed.

The controller 100 may determine at least one desired characteristics of the material at various locations in the system. The desired characteristics may be input to the system by a user (for example, as part of the design information provided to the controller 100), or can be calculated by the controller 100 optionally based on the input to the system by the user.

In some embodiments the controller 100 may be configured to dynamically vary outputs of the system between subsequent forming units.

The controller 100 may receive an input from the measurement system or module 101 relating to consolidation of the material, and compare this to a desired consolidation of the material at the particular location. In response the controller 100 may control the actuator(s) 11 to increase, decrease or maintain the forming force applied to the material.

The controller 100 may then receive a further input from the measurement system or module 101 relating to consolidation of the material at a further location and again compare this to desired characteristic at this location, and again in response the controller 100 may control the actuator(s) 11 of a subsequent forming unit to increase, decrease or maintain the forming force applied to the material.

The controller 100 may be configured to change or control an output of the system to ensure the desired characteristics of the material as formed are achieved.

The controller 100 may be configured to receive at least one input from the measurement system or module 101 of the material as formed to validate characteristics of the material as formed as against the desired characteristics of the material as formed.

The controller 100 may be configured to receive an input from said measurement system or module 101 relating to a characteristic of the material to be formed. The measurement system or module 101 may also provide information as to the location of measurement of the characteristic. The controller 101 may be configured to change an output in response to said input.

The controller may be configured to change the or an output to control one or more of:
the speed at which the apparatus advances the material to be formed, the speed at which the material to be formed is provided to the apparatus based on an output of the measurement system, a pressure applied to the system by the at least one forming unit, a tension applied to the material to be formed (optionally by the forming unit and/or the stretch unit), a material surface temperature (optionally a lower surface, and/or an upper surface of the material), a material core temperature, an alignment or orientation of the material to be formed relative to the apparatus and/or at least one forming unit.

The controller 100 or measurement system or module 101 may be configured to compare a measured characteristic against a predetermined characteristic. The controller 100 may modify and output of the apparatus based on a difference between the measured characteristic and the predetermined characteristic.

The controller 100 or measurement system or module 101 may be configured to compare a desired shape or profile against a measured shape or profile and based on the comparison the controller 100 may modify the shape or profile of the forming opening 3 and/or the forming surfaces 4. In this way any variations in the shape or profile of the material as it is formed can be accounted for during the forming process.

In some embodiments, the controller 100 may control the shape or profile of the forming opening 3 and/or the forming surfaces 4 of the final forming unit in response to a difference between the desired shape or profile and a measured shape or profile.

The controller 100 or the measurement system may be configured to compare a measured characteristic against a predetermined characteristic, and provide a user with an output if the measured characteristic is not within a tolerance of the predetermined characteristic.

The tolerance may include an allowance for shrinkage of material.

The controller 100 may be configured to control one or more outputs of the apparatus based on one or more inputs, wherein the one or more inputs comprise:
a desired profile or shape of the material to be formed, a weave direction or layout (optionally along a width or length of the material to be formed), a difference in material properties or type along a width or length of the material to be formed, an amount of desired material compression.

In some embodiments the apparatus may be configured to apply tension to the material to be formed.

The tension applied to the material to be formed 16 may be in at least one direction, the at least one direction may be one or more of:
along a length of the material to be formed, along a width of the material to be formed, along a height of the material to be formed, in the direction the material is advanced.

The at least one forming unit 2 may be configured to apply said tension to the material to be formed.

The apparatus may comprise a stretch unit 105 configured to apply said tension to the material to be formed.

The stretch unit 106 may comprise at least one fastening device 28. The fastening device 28 may comprise for example a clamp or brace or gripper. The fastening device 28 may be configured to fasten with or to the material to be formed 16 and/or advance the material to be formed. Such a fastening device 18 is shown in FIG. 18. The fastening device 28 may continuously engage an edge or surface of the material, or may engage an edge or surface of the material at discrete locations. As described above the fastening device 28 may act to advance the material to be formed.

The fastening device 28 may comprise at least one programmable or controllable fastening device. The controller 100 may be configured to control the at least one programmable or controllable fastening device.

The stretch unit 106 may comprises a least one pressure or force sensor. The pressure or force sensor may be configured to measure the tension provided to the material to be formed.

The at least one forming unit 2 may be configured to engage opposing surfaces of the material to be formed.

The tension provided maybe constant along the length of the apparatus.

The tension may vary along the length of the apparatus. For example, depending on the final desired shape or profile of the material.

The tension applied may allow for the material to stretched to form a desired shape or profile.

Also disclosed is a system or apparatus, the system comprising one or more of the apparatus or forming apparatus as described above.

The one or more apparatus may be configured to form one or more associated materials.

An output material from one or more apparatus may be provided as an input material into a subsequent one or more apparatus for further forming.

As shown in FIG. 22 the system or apparatus may comprises at least a first apparatus 61 as the one or more apparatus and a second apparatus 62 as the one or more apparatus.

The one or more apparatus, or first apparatus 61 and second apparatus 62 may arranged in parallel (as shown in FIG. 22) or series.

The first apparatus 61 may be configured to receive a first material 63 as a material to be formed, and the second apparatus 62 is configured to receive a second material 64 as a material to be formed.

The first apparatus 61 may be configured to impart a first resultant shape or first profile of a pre-determined formation upon the first material 63.

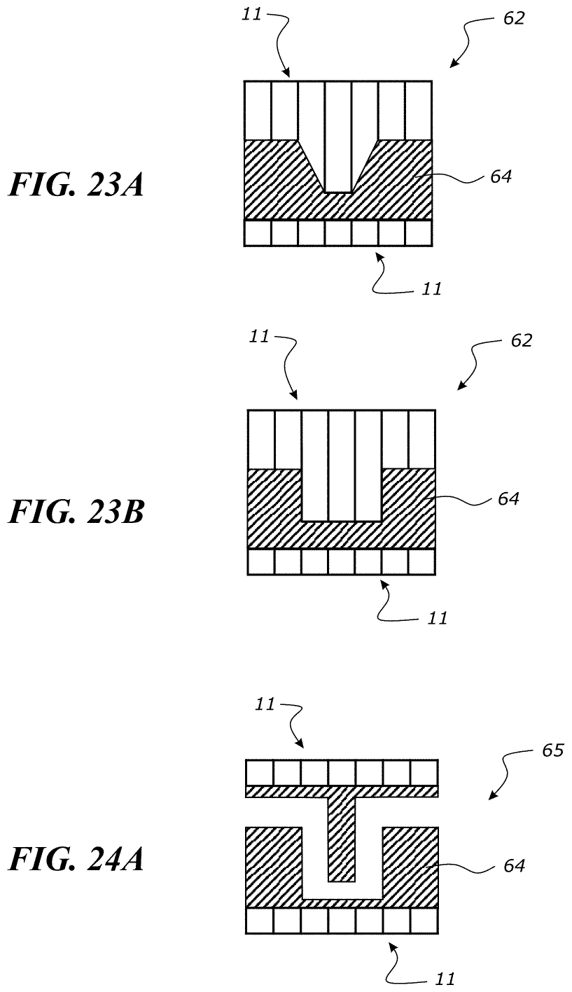

The second apparatus 62 may be configured to impart a second resultant shape or first profile of a pre-determined formation upon the second material 64. FIGS. 23A and 23B show example cross sections of a second apparatus 62 forming the second material 64.

It will be appreciated that further apparatuses may be provided.

The system may comprise a consolidation apparatus or third apparatus 65 as the one or more apparatus. The third apparatus 65 may be configured to receive the first material 63 and the second material 64 from the first apparatus 61 and the second apparatus 62 respectively, and form the first material 63 and second material 64 into a consolidated material 66.

In some embodiments, the consolidation apparatus may receive a plurality, at least 2, or 3, or 4 or more materials to be consolidated.

FIGS. 24A-24F show an example of the third apparatus 65 forming the first and second materials 63, 64 progressively to a final product as shown in FIG. 24F.

The first material 63 and second material 64 are formed into a consolidated material by one or more of:
application of a or the forming force, application of heat (optionally by the heating source or heating system).

Also disclosed is an apparatus for supporting a formed material once is has passed through a forming process.

The supporting apparatus 33 may form part of the forming apparatus and/or be located at an end of the forming apparatus to support the formed material 31.

The at least one support unit 30 may configured to support the formed material 31 once it has passed through the at least one forming opening 3 of the at least one forming unit 12.

The support unit 30 may be dynamically configurable so as to provide for a support surface 32 corresponding with the profile of the material as formed 31.

The support unit 30 may comprise one or more advancing actuators configured to advance the support unit with the formed material 31.

The support unit 30 may be configured to support and/or move the material as formed 31 from an end of the forming apparatus 1.

The at least one support 30 unit may comprise at least one vacuum cup configured to engage with a surface of the formed material 31. The at least one support 30 unit may comprise at least one vacuum cup configured to engage with an underside surface of the formed material 31.

The support apparatus 33 may comprise a plurality of support units 30 arranged in series and/or a grid like pattern.

The at least one support unit 30 may provide a continuous or non-continuous support surface.

The support surface 32 may be configured to match a profile of the material to be formed. The support surface 32 may be configured to match a profile of the underside of the material to be formed.

The support surface 32 may be supported by one or more actuators configured to modify the profile of the support surface.

The support unit 30 may comprises as least one gantry system.

FIG. 16 shows an example overview of the system. Controller 100 is configured to interface and/or control one or more of:

i. the measurement module/system 101,

ii. the automated machine tool station 102,

iii. the heating system 103,

iv. the cooling system 104,

v. the stretch unit 105.

In some embodiments a communication link may be provided between the controller 100 and one or more of the measurement module/system, the automated machine tool station 102, the heating system 103, the cooling system 104 the stretch unit 105 and/or one or more sub controllers. The communication link may be wired or wireless and may use any network or communication protocol.

In some embodiments each forming unit 2 comprises one or more forming unit controllers (for example, a sub controller). The forming unit controller may be configured to interface with and/or the one or more actuators 11 and to control one or more outputs of the actuators (for example, location of the actuator 11.)

In some embodiments one or more of sub-units may comprise a sub controller. In some embodiments one or more of the measurement module/system, the automated machine tool station 102, the heating system 103, the cooling system 104 and/or the stretch unit 105 may comprise one or more sub controllers. The sub controller may be configured to interface with the controller 100.

The controller 100 may control or instruct the sub controller for each sub-unit. In some embodiments the main controller will generate output information (for example, a set point) controller may communicate the output information to the or each sub controller. The sub controller may then control each sub-unit based on the output of the controller 100. The sub controller may pass information to the controller 100 (for example, measured values).

The controller 100 may receive any design inputs for example 3D models or other information indicative of the desired shape of the article. The controller may then generate desired outputs for the sub-units (for example, actuator control schemes and/or required heating or cooling profiles) and provide these to the sub controllers (for example, the forming unit controller or the heating and cooling systems).

Any received data by the controller 100 from the one or more sub-units or any other sensor of the system may be used by the controller 100 to modify outputs of the sub-units. These modified outputs may then be communicated to the sub-units.

The material to be formed 16 may be of a substantially uniform cross-section.

The material to be formed 16 may have a substantially rectangular cross section, optionally the material to be formed is a constant thickness, and/or width.

The width of the material to be formed 16 may vary along the length of the material to be formed.

The thickness of the material to be formed 16 may vary along the length of the material to be formed.

The material to be formed 16 may comprise a fibre layer and/or a core layer.

The material to be formed 16 may comprise one or more of:
tape, carbon fibre, woven fibre, reinforced fibre, fabric, metal, alloy, a composite material, unidirectional fibres, a thermoplastic resin, a thermoset resin, a core material, a metal core material, a hybrid thermoplastic material, additive manufacturing materials, a laminate, or any combination of the above.

It will be understood that the materials as described herein may comprise any suitable additive manufacturing material, or any material designed to create specific products for improves processing and performance. For example, any 3D printing technology materials as described herein.

The material to be formed 16 may comprise a plurality of layers.

The material may vary in material type along the length of the material.

The material may comprise one or more portions or sections, one or more sections comprising a different material type.

A pre-forming module 60 may be provided. The forming module may initially prepare the material for forming before the material is provided to the forming apparatus. In some embodiments the forming module 60 may consolidate the material.

The pre-forming module 60 may consolidate multiple layers of the material to be formed.

The pre-forming module 60 may comprise one or more actuators and/or actuator modules as described above. The actuators may be configured to apply force to the material to consolidate the material.

The pre-forming module 60 may further prepare the material to be formed to the correct dimensions (for example, thickness, width and/or length) before it is passed or advanced to the forming apparatus.

The pre-forming module 60 may comprise one or more heating sources or heating systems 103. The heating systems may comprise any of the feature as described above.

The heating systems 103 may comprise one or more plates. The plates may be an upper plate and a lower plate. In some embodiments the lower plate may act as a support for the material.

The pre-forming module 60 may also provide for a vacuum between a resilient membrane and the material (as described above).

A material preparation module may also be provided. The material preparation module may be located before the pre-forming module and/or the forming apparatus and be configured to prepare the material before forming. The material preparation module may from the material from a number of raw materials for example by creating a layered material. The material preparation module may also size the material for use in the pre-forming module and/or the forming apparatus.

Also disclosed is method of forming a material. The method may be as described above, and optionally using the apparatus described above.

The method may comprise the steps of:
advancing a material to be formed 16 through at least one forming opening 3 having at least one forming surface 4,
dynamically controlling the shape or profile of the forming surface 4 to impart a resultant shape or profile of a pre-determined formation upon the feed of material passing through said forming opening 3.

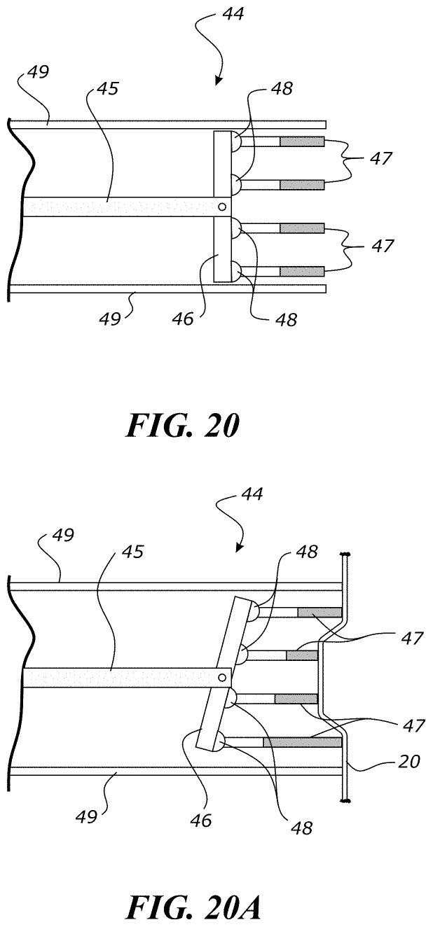

As shown in FIGS. 20 and 20A, also disclosed is an actuator unit 44.

The actuator 11 disclosed above may be or comprise the actuator unit 44.

In some embodiments the actuator unit 44 may comprise one or more actuators 11 as described above.

The actuator unit may comprise a rotatable shaft 45. The rotatable shaft 45 may be connected to a plate 46. One or more actuators 47 may be connected to the plate 46.

The actuator unit 44 may comprise a plurality of actuators 47 connected to the plate 46. The actuator unit 44 may comprise between 2 and 15 actuators 47 connected to the plate 46.

The plate 46 may be rotatably connectable and disconnectable, or engageable and disengageable, from the rotatable shaft 45 (for example by a clutch arrangement).

The actuator unit 44 may comprise a pivotable connection between the plate 46 and the rotatable shaft 45 (for example, as shown in FIGS. 20 and 20A.)

The actuator unit 44 may comprise at least one actuator configured to modify the angle of the plate 46 relative to the rotatable shaft 45 about said pivotable connection. The actuator may be one or more of a hydraulic, pneumatic or electric actuator. In some embodiments the actuator may be configured to engage a surface of the plate 46.

The actuator(s) 47 may be configured to vary in length, optionally, along a longitudinal axis.

The actuator(s) 47 may be arranged in a grid like pattern (for example as described above).

The actuator unit 44 may comprise an actuator connection 48. The actuator connection 48 may connect the at least one actuator 47 to the plate 46. In some embodiments, the actuator connection 48 may be configured to be moveable in at least one degree of freedom. In some embodiments, the actuator connection 48 may be configured to be moveable in one degree of freedom, or two degrees of freedom, or three degrees of freedom, or four degrees of freedom, or five degrees of freedom, or six degrees of freedom, or at least six degrees of freedom.

The at least one actuator 47 may be configured to provide for a forming surface 4.

The at least one actuator 47 may be configured to engage a compliant material or resilient membrane 20. In some embodiments an end surface of the actuator 47 may engage the compliant material or resilient membrane 20.

The at least one actuator may be configured to modify the profile of the compliant material or resilient membrane 20.

It will be appreciated the actuator 47 could be any variety of actuator. In some embodiments the actuator is a linear motion actuator. In some embodiments the at least one actuator may one or more of:
a robotic end effector, a vacuum actuator, a pneumatic actuator, a muscle actuator, a servo actuator, a hydraulic actuator, a voice coil actuator, a piezo actuator, a stepper actuator.

The motor may one or more of:
a stepper motor, a DC motor, an AC motor, an electronically controlled motor, a servo motor, a hybrid servo stepper motor, a muscle actuator, a pneumatic motor, a vacuum motor, a hydraulic motor, a voice coil motor, a piezo motor, a chain actuator.

The actuator unit 44 may comprise a housing 49, the housing 49 surrounding the at least one actuator(s) 47.

The housing 49 may comprise at least one shaft aperture. The shaft aperture may allow for the passage of the shaft into an inner portion of the housing 49. In some embodiments the motor may be disposed external to the housing 49. In some embodiments the motor may be disposed internally to the housing 49.

The motor may be configured to be connected to an end of the housing 49 at the shaft aperture. The motor and/or housing 49 may comprise one or more engagement features to connect the motor to the housing 49.

The material formed by the invention as described above may be used in various industries. For example, the aerospace, automotive medical, or other industries.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Where, in the foregoing description reference has been made to integers or components having known equivalents thereof, those integers are herein incorporated as if individually set forth.

The invention may also be said broadly to consist in the parts, elements and features referred to or indicated in the specification of the application, individually or collectively, in any or all combinations of two or more of said parts, elements or features.

Reference to any prior art in this specification is not, and should not be taken as, an acknowledgement or any form of suggestion that that prior art forms part of the common general knowledge in the field of endeavour in any country in the world.

Certain features, aspects and advantages of some configurations of the present disclosure have been described with reference to use of the gas humidification system with a respiratory therapy system. However, certain features, aspects and advantages of the use of the gas humidification system as described may be advantageously be used with other therapeutic or non-therapeutic systems requiring the humidification of gases. Certain features, aspects and advantages of the methods and apparatus of the present disclosure may be equally applied to usage with other systems.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

1. An apparatus for forming material, the apparatus comprising:
at least one forming unit, each said forming unit having at least one forming opening to receive a feed of material to be formed,
wherein at least one of said forming opening(s) comprises opposing or at least one forming surfaces,
at least one of said opposing forming surfaces being dynamically controllable into a pre-determined shape or profile to impart a resultant shape or profile of a pre-determined formation upon the feed of material passing through said forming opening of a said forming unit.

2. A process for forming material on a continuous or semi-continuous basis, the process comprising:
directing a feed of material to be formed to at least one forming unit, each said forming unit having at least one forming opening to receive the feed of material to be formed,
wherein at least one of said forming opening(s) comprises opposing or at least one forming surfaces,
at least one of said opposing forming surfaces being dynamically controllable into a pre-determined shape or profile to impart a resultant shape or profile of a pre-determined formation upon the feed of material passing through said forming opening of a said forming unit.

3. The apparatus or process of claim 1 or claim 2, wherein a pair of opposing forming surfaces are individually and dynamically controllable into a pre-determined shape or profile to impart a resultant shape or profile of a pre-determined formation upon the feed of material passing through said forming opening of a said forming unit.

4. The apparatus or process of any one of claims 1 to 3, wherein said apparatus or said process comprises a material advancer for advancing a feed of material to be formed to said opening of a said forming unit.

5. The apparatus or process of claim 4, wherein the material advancer is configured to advance the material to be formed towards and/or through the at least one forming opening of the at least one forming unit, so as to form the material into the pre-determined formation.

6. The apparatus or process of any one of claims 1 to 5, wherein the material is imparted with a pre-determined formation from each said forming unit.

7. The apparatus or process of any one of claims 1 to 6, wherein the material is sequentially fed through a sequentially arranged series of forming units, each said forming unit imparting the same or a different pre-determined formation to said material.

8. The apparatus or process of any one of claims 1 to 7, wherein said material achieves a resultant formation from a sequential application of forming forces imparted by a sequentially arranged series of said forming units.

9. The apparatus or process of any one of claims 1 to 8, wherein the apparatus or process comprises a controller.

10. The apparatus or process of claim 9, wherein the controller is configured to modify the cross-sectional shape of the forming unit, optionally, along a predefined direction.

11. The apparatus or process of any one of claims 1 to 10, wherein the forming opening is configured to apply pressure or force to the material to be formed.

12. The apparatus or process of claim 11, wherein the pressure or force changes the profile of the material to be formed as it passes through the forming opening.

13. The apparatus or process of claim 11 or claim 12, wherein the pressure or force promotes consolidation of the material to be formed.

14. The apparatus or process of any one of claims 11 to 13, wherein the pressure or force is applied via vibrations or micro-vibrations.

15. The apparatus or process of any one of claims 1 to 14, wherein one or more materials may be provided to the forming unit as said feed of material.

16. The apparatus or process of claim 15, wherein the one or more materials are formed into a consolidated material by the forming unit.

17. The apparatus or process of any one of claims 1 to 16, wherein the at least one forming opening comprises an inlet and an outlet, the material being configured to be passed through the inlet of the at least one forming opening and out the outlet of the at least forming opening.

18. The apparatus or process of any one of claims 1 to 17, wherein there are a plurality of forming openings.

19. The apparatus or process of any one of claims 1 to 18, wherein the forming opening is configured to be modifiable to vary the size and or shape of the forming opening.

20. The apparatus or process of any one of claims 1 to 19, wherein the forming unit comprises inlet actuators configured to modify or vary the cross-sectional area of the or an inlet of the at least one forming opening.

21. The apparatus or process of any one of claims 1 to 20, wherein the forming unit comprises outlet actuators configured to modify or vary the cross-sectional area of the or an outlet of the at least one forming opening.

22. The apparatus or process of any one of claims 1 to 21, wherein the forming unit comprises at least one module, the at least one module configured to define a surface of profile of the forming opening.

23. The apparatus or process of any one of claims 1 to 22, wherein the forming unit comprises an upper or top module, the upper or top module configured to define an upper or top profile of the forming opening.

24. The apparatus or process of any one of claims 1 to 23, wherein the forming unit comprises a lower or bottom module, the lower or bottom module configured to define a lower or bottom profile of the forming opening.

25. The apparatus or process of claim 24, wherein the upper or top module is a mirror image of the lower or bottom module.

26. The apparatus or process of claim 24 or claim 25, wherein the upper or top module and the lower or bottom module are substantially the same width and length.

27. The apparatus or process of any one of claims 24 to 26, wherein a width of the upper or top module and the lower or bottom module is substantially the same as the material to be formed.

28. The apparatus or process of any one of claims 1 to 27, wherein the forming unit comprises one or more side module(s), the side module(s) configured to define one or more sides of the forming opening.

29. The apparatus or process of claim 28, wherein the one or more side modules comprise a first side module and a second side module.

30. The apparatus or process of claim 29, wherein the first side module and second side module are located on opposite sides of the forming opening.

31. The apparatus or process of any one of claims 1 to 30, wherein the forming unit comprises at least one actuator, the at least one actuator configured to modify or vary the cross-sectional area of the forming opening.

32. The apparatus or process of claim 31, wherein the at least one actuator may be configured to modify the pre-determined shape or profile of the forming surfaces.

33. The apparatus or process of claim 31 or claim 32, wherein an end surface of the actuator is configured to define at least part of the pre-determined shape or profile of the forming surfaces.

34. The apparatus or process of any one of claims 31 to 33, wherein at least one actuator comprises an end cap, the end cap defining the end surface of the actuator.

35. The apparatus or process of claim 34, wherein the end cap is connectable and disconnectable from the at least one actuator.

36. The apparatus or process of claim 34 or claim 35, wherein a profile and/or surface of the end cap is dynamically controllable.

37. The apparatus or process of any one of claims 34 to 36, wherein the end cap is connectable to and disconnectable from one or more end cap of an adjacent actuator(s).

38. The apparatus or process of any one of claims 34 to 37, wherein each end cap comprises a connection feature (optionally a channel), the connection feature allowing for connection and disconnection between the end cap of adjacent actuator(s).

39. The apparatus or process of any one of claims 34 to 38, wherein a plurality of connected end caps forms said forming surface.

40. The apparatus or process of any one of claims 1 to 39, wherein the or at least one module comprises at least one actuator module, the actuator module comprising at least one actuator.

41. The apparatus or process of any one of claims 1 to 40, wherein the or an upper or top module comprises an upper or top actuator module, the upper or top actuator module comprising at least one actuator.

42. The apparatus or process of any one of claims 1 to 41, wherein the or a lower or bottom module comprises a lower or bottom actuator module, the lower or bottom actuator module comprising at least one actuator.

43. The apparatus or process of any one of claims 1 to 42, wherein the or one or more side module(s), comprises a side actuator module the side actuator module comprising at least one actuator.

44. The apparatus or process of any one of claims 31 to 43, wherein each actuator or a group of actuators, or the actuator module is configured to be independently controlled.

45. The apparatus or process of claim 44, wherein each actuator or a group of actuators, or the actuator module is configured to be moveable (optionally along a length and/or width of the material).

46. The apparatus or process of claim 44 or claim 45, wherein each actuator or a group of actuators, or the actuator module is configured to be moveable in a direction along the apparatus or process, and/or a direction parallel to the apparatus or process.

47. The apparatus or process of any one of claims 44 to 46, wherein each actuator or a group of actuators, or the actuator module is configured to be movable by the one or more actuators.

48. The apparatus or process of any one of claims 31 to 47, wherein a first actuator or a first group of actuators, or a first actuator module is configured to be controlled independently from a second actuator or a second group of actuators, or second actuator module.

49. The apparatus or process of claim 48, wherein the first actuator or the first group of actuators, or the first actuator module is controlled to engage a surface of the material, while the second actuator or the second group of actuators, or the second actuator module is being moved to a desired position.

50. The apparatus or process of claim 48 or claim 49, wherein the second actuator or the second group of actuators, or the second actuator module is controlled to engage a surface of the material, while the first actuator or the first group of actuators, or the first actuator module is being moved to a desired position.

51. The apparatus or process of any one of claims 1 to 50, wherein the or a controller is configured to control the position of at least one actuator to modify or vary the cross-sectional area of the forming opening.

52. The apparatus or process of any one of claims 1 to 50, wherein the at least one actuator is controlled by the or a controller to reach a first predetermined location (or a first desired stroke length).

53. The apparatus or process of claim 52, wherein the first predetermined location corresponds to or with a material hold position.

54. The apparatus or process of any one of claims 1 to 50, wherein the at least one actuator is controlled by the controller to apply a predetermined forming force to the material to be formed.

55. The apparatus or process of claim 54, wherein the predetermined forming force is applied to the material to be formed by advancing to a second predetermined location (or a second desired stroke length).

56. The apparatus or process of claim 55, wherein the predetermined forming force is applied to the material to be formed by advancing between at least a first and a second predetermined location of the actuator (or at least a first and a second desired stroke length).

57. The apparatus or process of claim 55, wherein the predetermined forming force is applied to the material to be formed by pulsing or vibrating between at least a first and a second predetermined location of the actuator (or at least a first and a second desired stroke length).

58. The apparatus or process of any one of claims 54 to 57, wherein the predetermined forming force is applied to the material to be formed based on an output from a force sensor (optionally the force sensor being located in the actuator and/or forming unit and/or material to be formed).

59. The apparatus or process of any one of claims 54 to 58, wherein the or a controller is configured to control the actuator to apply said predetermined forming force for a predetermined time.

60. The apparatus or process of any one of claims 52 to 59 wherein the at least one actuator is controlled by the controller to reach a third predetermined location (or a third desired stroke length).

61. The apparatus or process of claim 60, wherein the third predetermined location corresponds to or with a material hold position.

62. The apparatus or process of any one of claims 1 to 61, wherein the controller is configured to control the or a actuator in accordance with an actuator control scheme, said actuator control scheme being to move to said or a first predetermined location, then apply said or a predetermined forming force for said predetermined amount of time, and then move to said or a third predetermined location.

63. The apparatus or process of claim 62, wherein said actuator control scheme is undertaken continuously.

64. The apparatus or process of claim 62 or claim 63, the material is advanced between each actuator control scheme.

65. The apparatus or process of any one of claims 62 to 64, wherein the one or more of:
the first predetermined location,
predetermined forming force (or the second predetermined location),
the third predetermined location,
is controlled to be varied for each actuator control scheme.

66. The apparatus or process of any one of claims 62 to 65, wherein the predetermined forming force increases or decreases for each actuator control scheme.

67. The apparatus or process of any one of claims 62 to 66, wherein the actuator control scheme further comprises apply a first predetermined forming force, followed by a one or more further predetermined forming force(s).

68. The apparatus or process of claim 67, wherein the actuator control scheme further comprises moving the actuators to a material hold position between each application of a forming force.

69. The apparatus or process of claim 67 or claim 68, wherein the first predetermined force is larger or smaller than the one or more further predetermined forming force(s).

70. The apparatus or process of any one of claims 62 to 69, wherein the controller is configured to determine or calculate said actuator control scheme, in accordance with the profile of the material as formed, or the material to be formed.

71. The apparatus or process of any one of claims 1 to 70, wherein the actuators are configured to engage a surface of the material substantially concurrently, so as to apply said forming force concurrently such that the application of a localised force is prevented or minimised.

72. The apparatus or process of any one of claims 1 to 71, wherein at least one actuator comprises at least one swivelling portion, optionally the at least one swivelling portion is configured to be moveable in at least one degree of freedom (optionally one degree of freedom, or two degrees of freedom, or three degrees of freedom, or four degrees of freedom, or five degrees of freedom, or six degrees of freedom).

73. The apparatus or process of claim 72, wherein the swivelling portion is located at an end and/or a base of said at least one actuator.

74. The apparatus or process of claim 72 or claim 73, wherein the at least one swivelling portion comprises a resilient membrane.

75. The apparatus or process of claim 74, wherein a heat protection layer, or heat shield is provided over and/or the resilient membrane.

76. The apparatus or process of claim 75, wherein the heat protection layer, or heat shield comprises a metal foil layer, or a ceramic layer.

77. The apparatus or process of claim 76, wherein the heat protection layer, or heat shield mitigates or prevents heat transfer from the material to be formed.

78. The apparatus or process of any one of claims 72 to 77, wherein there are a plurality of actuators.

79. The apparatus or process of claim 78, wherein each actuator comprises an associated swivelling portion.

80. The apparatus or process of any one of claims 72 to 79, wherein each actuator and/or the forming surface is provided with a releasing agent, the releasing agent configured to allow for release of the actuator and/or the forming surface from the resilient membrane and/or the material to be formed.

81. The apparatus or process of any one of claims 1 to 80, wherein the forming apparatus or process comprises at least one resilient membrane.

82. The apparatus or process of claim 81, wherein the at least one resilient membrane is provided (optionally on an inner surface of the at least one resilient membrane) with at least one release film and/or at least one release fabric configured to contact a surface of the material to be formed.

83. The apparatus or process of claim 82, wherein the at least one release film and/or the at least one release fabric is configured to allow for the release of the resilient membrane from the material to be formed.

84. The apparatus or process of any one of claims 81 to 83, wherein the resilient membrane comprises an upper resilient membrane and a lower resilient membrane.

85. The apparatus or process of claim 84, wherein the upper resilient membrane and the lower resilient membrane form an enclosed resilient membrane (optionally the upper resilient membrane and the lower resilient membrane are joined at or along at least one edge).

86. The apparatus or process of any one of claims 81 to 85, wherein the resilient membrane is formed over said plurality of actuators, or said associated swivelling portions, the resilient membrane defining a surface for contact with the material to be formed.

87. The apparatus or process of any one of claims 81 to 86, wherein the resilient membrane overlays the at least one forming surface, and/or plurality of actuators and/or said associated swivelling portions.

88. The apparatus or process of any one of claims 81 to 87, wherein the or a lower or bottom module and/or a lower or bottom forming surface comprises a lower or bottom resilient membrane.

89. The apparatus or process of claim 88, wherein the lower or bottom resilient membrane defines a lower or bottom surface of the forming opening.

90. The apparatus or process of any one of claims 81 to 89, wherein the side module and/or a side forming surface comprises a side resilient membrane.

91. The apparatus or process of claim 90, wherein the side resilient membrane defines a side surface of the forming opening.

92. The apparatus or process of any one of claims 81 to 91, wherein or the or an upper or top module and/or a upper or top forming surface comprises a upper or top resilient membrane.

93. The apparatus or process of claim 92, wherein the upper or top resilient membrane defines a upper or top surface of the forming opening.

94. The apparatus or process of any one of claims 81 to 93, wherein the at least one resilient membrane comprises a heat shield.

95. The apparatus or process of any one of claims 81 to 94, wherein the heat shield is configured to engage a surface of the material to be formed as it passes through the at least one forming opening.

96. The apparatus or process of any one of claims 81 to 95, wherein a vacuum is created between the resilient membrane and/or heat shield and a surface of the material to be formed, optionally the vacuum is created by a vacuum pump.

97. The apparatus or process of claim 96, wherein the resilient membrane and/or heat shield is provided with at least one vacuum port (optionally the vacuum port comprises at least one one-way valve).

98. The apparatus or process of claim 97, wherein the vacuum port is located outside a boundary of the material to be formed.

99. The apparatus or process of any one of claims 96 to 98, wherein the forming apparatus or process comprises one or more rollers configured create said vacuum.

100. The apparatus or process of claim 99, wherein the vacuum promotes consolidation of the material to be formed.

101. The apparatus or process of any one of claims 81 to 100, wherein the resilient membrane is configured to remain in contact with a surface of the material to be formed.

102. The apparatus or process of any one of claims 81 to 101, wherein when the or a vacuum is formed between the resilient membrane and/or heat shield and the material to be formed, and the actuators retracted, the vacuum formed maintains the resilient membrane and/or heat shield in contact with a surface of the material to be formed.

103. The apparatus or process of any one of claims 81 to 102, wherein the resilient membrane is connectable and disconnectable from said or a swivelling portion.

104. The apparatus or process of any one of claims 1 to 103, wherein the forming apparatus or process and/or each forming unit comprises one or more heat source(s) or heating system(s).

105. The apparatus or process of claim 104, wherein the one or more heat source(s) or heating system(s) comprises one or more of: a microwave heating source, an infrared source, gas heating, air heating, electrical heating, induction heating, electromagnetic induction heating.

106. The apparatus or process of any one of claims 1 to 105, further comprising at least one embedded sensor in or on the material to be formed, and wherein the apparatus or process is configured to monitor the embedded sensor to determine a characteristic of the material to be formed.

107. The apparatus or process of claim 106, wherein the embedded sensor is one or more of: a strain sensor, a stress sensor, a temperature sensor, a pressure sensor, a force sensor, a light sensor, a UV sensor, or another sensor applicable to product manufacture and/or life cycle.

108. The apparatus or process of claim 106 or claim 107, wherein the or a controller is configured to receive a signal from said one or more embedded sensor(s) indicative of the characteristic of the material to be formed, and control the apparatus or process based on the signal.

109. The apparatus or process of any one of claims 104 to 108, wherein each forming unit comprises one or more temperature sensors configured to monitor the temperature of a surface, and/or a core of the material to be formed.

110. The apparatus or process of any one of claims 104 to 109, wherein the apparatus or process is divided into a series of zones, said zones being a lengthwise portion of the apparatus or process, each zone comprising at least heat source(s) or heating system(s) and at least one temperature sensor configured to monitor the temperature of a surface, and/or a core of the material to be formed.

111. The apparatus or process of any one of claims 104 to 110, wherein the or a controller is configured to receive a signal from said one or more temperature sensors indicative of the temperature of the material to be formed, and based on the signal control the power provided to the heat source(s) or heating system(s).

112. The apparatus or process of claim 110 or claim 111, wherein the temperature sensor comprises one or more of: an infrared temperature sensor, an optical temperature sensor, a microwave measuring system.

113. The apparatus or process of any one of claims 110 to 112, wherein the or a controller controls the power provided to the heat source(s) or heating system(s), based on a difference between the signal received from said one or more temperature sensors indicative of the temperature of the material to be formed and a desired temperature.

114. The apparatus or process of any one of claims 104 to 113, wherein the heat source or heating system is located in one or more of:
the upper or top module, and/or the upper or top forming surface,
the lower or bottom module, and/or the lower or bottom forming surface,
the side module(s), and/or the side forming surface,
a or the zone of said apparatus or process (optionally said zone being a lengthwise portion of the apparatus or process).

115. The apparatus or process of any one of claims 1 to 114, wherein there are a plurality of forming units.

116. The apparatus or process of claim 115, wherein the plurality of forming units are arranged in series, such that the material passes through a first forming unit, and to subsequent further forming units.

117. The apparatus or process of claim 115 or claim 116, wherein the plurality of forming units are configured to gradually change the profile of the material gradually as the material is passed through each of said plurality of forming units.

118. The apparatus or process of any one of claims 115 to 117, wherein the material to be formed is of a first profile, and wherein each forming unit is configured to form the material to a corresponding intermediate profile, and wherein the final forming unit of the plurality of forming units is configured to form the material to a final profile.

119. The apparatus or process of any one of claims 115 to 118, wherein the forming opening of a penultimate forming unit has the same shape as the forming opening of a final forming unit.

120. The apparatus or process of any one of claims 115 to 119, wherein a forming unit of said at least one forming unit is configured to transfer said material to be formed to an adjacent forming unit of said at least one forming unit.

121. The apparatus or process of claim 120, wherein the forming unit of said at least one forming unit is configured to transfer the material to be formed by moving from a first location towards a second location, the second location being adjacent the adjacent forming unit so as to provide the material to be formed to the adjacent forming unit and/or advance the material to be formed.

122. The apparatus or process of claim 120 or claim 121, wherein on transfer from a forming unit to an adjacent forming unit, the adjacent unit is configured to engage the material to be formed, and wherein after the engagement between the adjacent forming unit and the material to be formed has been created an engagement between the first forming unit and the material to be formed is released.

123. The apparatus or process of claim 122, wherein said engagement is a vacuum or a negative pressure device.

124. The apparatus or process of any one of claims 120 to 123, wherein subsequent to transfer of the material to be formed from the forming unit is configured to move from the second location towards the first location.

125. The apparatus or process of any one of claims 115 to 124, wherein there are a plurality of forming units and each forming unit is configured to the transfer of said material to be formed an adjacent forming unit in a staggered manner.

126. The apparatus or process of any one of claims 1 to 125, wherein the forming opening is configured to be modifiable to vary the location and/or orientation of the forming opening relative to the material to be formed as it is advanced.

127. The apparatus or process of any one of claims 1 to 120, wherein each, or a group of said at least one forming units is supported by a forming unit support, optionally, the forming unit support comprises a plate, or a rail.

128. The apparatus or process of claim 127, wherein the at least one forming unit, or the forming unit support is connected to, or carried by at least one robotic arm, optionally the forming unit or the forming unit support is connected to the robotic arm via a robot end effector.

129. The apparatus or process of claim 128, wherein the at least one forming unit, or forming unit support is moved by said robotic arm.

130. The apparatus or process of any one of claims 1 to 129, wherein the least one forming unit is actuated by at least one actuator, to adjust the location of the forming opening relative to the material to be formed.

131. The apparatus or process of claim 130, wherein the at least one actuator comprises one or more of:
a vertical actuator configured to vertically modify the location of the forming unit and/or forming opening relative to a vertical reference plane (i.e. a plane perpendicular to a ground plane),
a horizontal actuator configured to horizontally modify the location of the forming unit and/or forming opening relative to a horizontal reference plane (i.e. a plane parallel to a ground plane),
a tilt actuator configured to tilt the forming unit and/or forming opening relative to a reference plane (i.e. a ground plane).

132. The apparatus or process of claim 130 or claim 131, wherein the at least one forming unit is configured to actuated by said at least one actuator over a predetermined path (optionally by a or the controller).

133. The apparatus or process of claim 132, wherein a velocity of the at least one forming unit along said predetermined path is based on one or more of:
the speed at which the apparatus or process advances the material to be formed,
the speed at which the material to be formed is provided to the apparatus or process,
the temperature of a part of the material to be formed (for example a core temperature or a surface temperature),
at least one output of the or a measurement module.

134. The apparatus or process of any one of claims 130 to 133, wherein the actuation of the or each forming unit is configured to create a varying shape or profile of the material to be formed.

135. The apparatus or process of any one of claims 1 to 134, wherein the material is advanced at a continuous rate.

136. The apparatus or process of claim 135, wherein the material is advanced at about 3 metres/minute.

137. The apparatus or process of claim 135 or claim 136, wherein the rate at which the material is advanced is based on one or more of:
actuator speed (for example the speed at which the actuators can proceed through an actuator control scheme either as a maximum speed or a controlled speed),
the number of actuators (for example the number of actuators which form a forming surface),
an amount of heat supplied, or able to be supplied by the heating source,
a vacuum supplied, or able to be supplied by the vacuum source.

138. The apparatus or process of any one of claims 1 to 137, wherein one or more forming units at the end of the plurality of forming units are configured to be moved by said actuator to shape a final profile of the material to be formed.

139. The apparatus or process of claim 138, wherein the movement of said one or more forming units at the end of the plurality of forming units is controlled by said actuator to provide for one or more of:
a substantially continuously curved profile,
a substantially concave or convex profile,
a profile comprising a curved portion (for example a compound curve),
a profile comprising at least one substantially straight portion.

140. The apparatus or process of any one of claims 1 to 139, wherein the forming apparatus or process is configured to form the material to be formed into a plurality of portions, each of the plurality of portions having an associated profile or cross-section.

141. The apparatus or process of claim 140, wherein the associated profile or cross-section of each of the plurality of portions are different.

142. The apparatus or process of any one of claims 1 to 141, wherein the forming apparatus or process is configured to form the material to be formed into at least a first portion having a first profile, a second portion having a second profile, and a third portion having a third portion.

143. The apparatus or process of claim 142, wherein the first profile, the second profile and the third profile are different.

144. The apparatus or process of claim 142 or claim 143, wherein the forming apparatus or process is configured to form the material to be formed into at least a subsequent portion having an associated subsequent profile.

145. The apparatus or process of any one of claims 1 to 144, wherein the forming apparatus or process comprises an automated machine tool station configured to trim, and or cut and or drill apertures in the material as formed.

146. The apparatus or process of claim 145, wherein the automated machine tool station comprises a computer numerical control (CNC) machine.

147. The apparatus or process of claim 145 or claim 146, wherein the automated machine tool station comprises a laser or water cutting system.

148. The apparatus or process of any one of claims 1 to 147, wherein the advancer is one or more of:
a roller, or an intelligent roller system,
one or more conveyers (optionally located before, after or between forming units,
the movement of the plurality of forming units,
at least one fastening device (for example a clamp or brace or the or a stretch unit configured to apply tension to the material to be formed) optionally, the fastening device configured to fasten with or to the material to be formed and advance to advance the material to be formed,
an edge actuator (optionally as part of the module) configured to engage an edge of the material to be formed (optionally the edge actuators comprise a pair of opposing edge actuators configured to engage opposing sides of the material to be formed).

149. The apparatus or process of any one of claims 1 to 148, wherein the actuators and/or one or more forming units are or comprises a roller or set of rollers.

150. The apparatus or process of any one of claims 1 to 149, wherein the apparatus or process comprises at least one cooling system, configured to cool the material.

151. The apparatus or process of claim 150, wherein the at least one cooling system is configured to cool the material once it passes through said at least one forming unit.

152. The apparatus or process of claim 150 or claim 151, wherein the controller is configured to control the at least one cooling system to cool the material in accordance with a cooling profile,

153. The apparatus or process of any one of claims 150 to 152, wherein the controller is configured to control the at least one cooling system to control the removal of heat from the material to be formed or as formed.

154. The apparatus or process of any one of claims 150 to 153, wherein the controller is configured to control the at least one cooling system based on an output of the measurement module (for example a temperature).

155. The apparatus or process of any one of claims 150 to 154, wherein the at least one cooling system comprises one or more of: air cooling, water cooling, turbulent water cooling, a water jacket, nitrogen cooling, ice cooling.

156. The apparatus or process of any one of claims 150 to 155, wherein the at least one cooling system is provided to the resilient membrane and/or the resilient membrane by at least one roller system.

157. The apparatus or process of any one of claims 1 to 156, wherein the apparatus or process further comprises at least one measurement module, wherein the measurement module measures characteristics of the material to be formed during forming, and/or the material as formed.

158. The apparatus or process of any one of claims 1 to 157, wherein there is provided a measurement system as part of the or a material preparation module and/or the pre-forming module and/or the apparatus or process.

159. The apparatus or process of claim 157 or claim 158, wherein the measurement module comprises at least one laser measurement system, or computer vision or robotically observable measurement.

160. The apparatus or process of any one of claims 157 to 159, wherein the measurement system is configured to measure one or more of the following characteristics:
a. fibre orientation or fibre alignment,
b. weave orientation or weave alignment,
c. material thickness,
d. material width,
e. material length,
f. material cross-sectional profile,
g. material side profile,
h. fibre or material quality,
i. material surface temperature (optionally a lower surface, and/or an upper surface of the material),
j. material core temperature,
k. a pressure applied to the material to be formed (optionally by the forming unit, and/or by said vacuum),
l. a tension applied to the material to be formed (optionally by the forming unit and/or the stretch unit),
m. material compression or material crystallisation,
n. any air pockets or voids in the material,
o. stretch or material strength.

161. The apparatus or process of any one of claims 157 to 160, wherein the controller is configured to receive an input from said measurement system relating to a characteristic of the material to be formed, and optionally the location of measurement of the characteristic, and wherein the controller is configured to change or control an output in response to said input.

162. The apparatus or process of claim 161, wherein the controller is configured to change the or an output to control one or more of:
a. the speed at which the apparatus or process advances the material to be formed,
b. the speed at which the material to be formed is provided to the apparatus or process based on an output of the measurement system,
c. a pressure applied to the system by the at least one forming unit,
d. a tension applied to the material to be formed (optionally by the forming unit and/or the stretch unit),
e. a material surface temperature (optionally a lower surface, and/or an upper surface of the material),
f. a material core temperature,
g. an alignment or orientation of the material to be formed relative to the apparatus or process and/or at least one forming unit.

163. The apparatus or process of any one of claims 157 to 162, wherein the controller or measurement system is configured to compare a measured characteristic against a predetermined characteristic, and modify and output of the apparatus or process based on a difference between the measured characteristic and the predetermined characteristic.

164. The apparatus or process of any one of claims 157 to 163, wherein the controller or measurement system is configured to compare a measured characteristic against a predetermined characteristic, and provide a user with an output if the measured characteristic is not within a tolerance of the predetermined characteristic.

165. The apparatus or process of claim 164, wherein the tolerance includes an allowance for shrinkage or spring back of material.

166. The apparatus or process of any one of claims 157 to 165, wherein the controller is configured to control one or more outputs of the apparatus or process based on one or more inputs, wherein the one or more inputs comprise:
a desired profile or shape of the material to be formed,
a weave direction or layout (optionally along a width or length of the material to be formed),
a difference in material properties or type along a width or length of the material to be formed,
an amount of desired material compression.

167. The apparatus or process of any one of claims 1 to 166, wherein the apparatus or process is configured to apply tension to the material to be formed.

168. The apparatus or process of claim 167, the tension applied to the material to be formed is in at least one direction, the at least one direction being one or more of:
along a length of the material to be formed,
along a width of the material to be formed,
along a height of the material to be formed,
in the direction the material is advanced.

169. The apparatus or process of claim 167 or claim 168, wherein the at least one forming unit is configured to apply said tension to the material to be formed.

170. The apparatus or process of any one of claims 1 to 169, wherein the apparatus or process comprises a stretch unit configured to apply said tension to the material to be formed.

171. The apparatus or process of claim 170, wherein the stretch unit advances the material to be formed.

172. The apparatus or process of claim 170 or claim 171, wherein the stretch unit is an intelligent conveyor system.

173. The apparatus or process of any one of claims 170 to 172, wherein the stretch unit comprises at least one fastening device (for example a clamp or brace or gripper) optionally, the fastening device configured to fasten with or to the material to be formed and advance the material to be formed.

174. The apparatus or process of claim 173, wherein the fastening device comprises at least one programmable or controllable fastening device, and optionally wherein the controller is configured to control the at least one programmable or controllable fastening device.

175. The apparatus or process of any one of claims 170 to 174, wherein the stretch unit comprises a least one pressure or force sensor, wherein the pressure or force sensor is configured to measure the tension provided to the material to be formed.

176. The apparatus or process of any one of claims 167 to 175, wherein the at least one forming unit is configured to engage opposing surfaces of the material to be formed.

177. The apparatus or process of any one of claims 167 to 176, wherein the tension provided is constant along the length of the apparatus or process

178. The apparatus or process of any one of claims 167 to 177, wherein the tension varies along the length of the apparatus or process.

179. A system, wherein the system comprises one or more of the apparatus or process of any one of the preceding claims.

180. The system of claim 179, wherein an output material of one or more apparatus or process is provided as an input material to a subsequent apparatus or process.

181. The system of claim 179 or claim 180, wherein the system comprises at least a first apparatus or process as the one or more apparatus or process and a second apparatus or process as the one or more apparatus or process.

182. The system of claim 181, wherein the first apparatus or process and second apparatus or process are arranged in parallel.

183. The system of claim 181 or 182, wherein the first apparatus or process is configured to receive a first material as a material to be formed, and wherein the second apparatus or process is configured to receive a second material as a material to be formed.

184. The system of claim 183, wherein the first apparatus or process is configured to impart a first resultant shape or first profile of a pre-determined formation upon the first material.

185. The system of claim 184, wherein the second apparatus or process is configured to impart a second resultant shape or first profile of a pre-determined formation upon the second material.

186. The system of any one of claims 183 to 185, wherein the system comprises a third apparatus or process or consolidation apparatus or process as the one or more apparatus or process, the third apparatus or process being configured to receive the first material and the second material, and form the first material and second material into a consolidated material.

187. The system of any one of claims 183 to 186, wherein the first material and second material are formed into a consolidated material by one or more of:
application of a or the forming force,
application of heat (optionally by the heating source or heating system).

188. An apparatus or process configured to form, as a material to be formed, on or more of:
a thermoplastic or thermoset material,
a hybrid thermoplastic material,
a metal core material,
a thermoplastic or thermoset core material,
a composite material.

189. The apparatus or process of claim 188, wherein the material to be formed may comprise one or more of: tape, carbon fibre, woven fibre, reinforced fibre, fabric, metal, a composite material, unidirectional fibres.

190. The apparatus or process of claim 188 or claim 189, wherein the apparatus or process further comprises a roller system and/or a vacuum system configured to remove air between multiple layers.

191. The apparatus or process of any one of claims 188 to 190, wherein the apparatus or process comprises at least one heating source or heating system, wherein the heating source is configured to heat the thermoplastic material.

192. The apparatus or process of claim 191, wherein the apparatus or process comprises a plurality of heating sources or heating systems arranged in series.

193. The apparatus or process of claim 192, wherein the heat provided by the heating source or heating system is configured to allow for consolidation of the material to be formed.

194. An apparatus or process for supporting a formed material once is has passed through a forming process, the apparatus or process comprising:
at least one support unit configured to support the formed material once it has passed through the at least one forming opening of the at least one forming unit

195. The apparatus or process of claim 194, wherein the support unit if dynamically configurable so as to provide for a support surface corresponding with the profile of the material as formed.

196. The apparatus or process of claim 194 or claim 195, wherein the support unit comprises one or more advancing actuators configured to advance the support unit with the material.

197. The apparatus or process of any one of claims 194 to 196, wherein the support unit is configured to support and/or move the material as formed from an end of the forming apparatus or process.

198. The apparatus or process of any one of claims 194 to 197, wherein the at least one support unit comprises at least one vacuum cup configured to engage with a surface of the formed material.

199. The apparatus or process of any one of claims 194 to 198, wherein the apparatus or process comprises a plurality of support units arranged in series and/or a grid like pattern.

200. The apparatus or process of any one of claims 194 to 199, wherein the at least one support unit provides a continuous or non-continuous support surface.

201. The apparatus or process of any one of claims 194 to 200, wherein the support surface is configured to match a profile of the material to be formed.

202. The apparatus or process of any one of claims 194 to 201, wherein the support surface is supported by one or more actuators configured to modify the profile of the support surface.

203. The apparatus or process of any one of claims 194 to 202, wherein the support unit comprises as least one gantry system.

204. The apparatus or process of any one of claims 194 to 203, wherein the material to be formed is of a substantially uniform cross-section.

205. The apparatus or process of any one of claims 194 to 204, wherein the material to be formed is has a substantially rectangular cross section, optionally the material to be formed is a constant thickness, and/or width.

206. The apparatus or process of any one of claims 194 to 205, wherein one or more of:
the width of the material to be formed,
the thickness of the material to be formed,
vary along the length of the material to be formed.

207. The apparatus or process of any one of claims 194 to 206, wherein the material to be formed comprises a fibre layer and/or a core layer.

208. The apparatus or process of any one of claims 194 to 207, wherein the material to be formed comprises one or more of: tape, carbon fibre, woven fibre, reinforced fibre, fabric, metal, a composite material, unidirectional fibres, a thermoplastic or thermoset resin, a core material.

209. The apparatus or process of any one of claims 194 to 208, wherein the material to be formed comprises a plurality of layers.

210. A method of forming a material according to any preceding claim.

211. A method of forming a material, the method comprising:
advancing a material to be formed through at least one forming opening having at least one forming surface,
dynamically controlling the shape or profile of the forming surface to impart a resultant shape or profile of a pre-determined formation upon the feed of material passing through said forming opening of a said forming unit.

212. A method of forming a material comprising:
providing or directing the material to be formed to at least one forming unit, each said forming unit having at least one forming opening to receive the material to be formed,
wherein at least one of said forming opening(s) comprises opposing or at least one forming surfaces, and
dynamically controlling at least one of said opposing forming surfaces into a pre-determined shape or profile to impart a resultant shape or profile of a pre-determined formation upon the material passing through said forming opening of a said forming unit.

213. An actuator unit comprising:
a rotatable shaft,
a plate connected to the rotate shaft,
at least one actuator connected to the plate.

214. The actuator unit of claim 213, wherein the actuator unit comprises a motor, the motor configured to rotate the rotatable shaft.

215. The actuator unit of claim 213 or claim 214, wherein the actuator unit comprises a plurality of actuators connected to the plate (optionally the actuator unit comprises between 2 and 15 actuators connected to the plate).

216. The actuator unit of any one of claims 213 to 215, wherein the plate is rotatably connectable and disconnectable from the rotatable shaft.

217. The actuator unit of any one of claims 213 to 216, wherein the actuator unit comprises a pivotable connection between the plate and the rotatable shaft.

218. The actuator unit of any one of claims 213 to 217, wherein the actuator unit comprises at least one actuator configured to modify the angle about said pivotable connection, (optionally said actuator is one or more of a hydraulic, pneumatic or electric actuator).

219. The actuator unit of any one of claims 213 to 218, wherein the actuator is configured to vary in length, optionally, along a longitudinal axis.

220. The actuator unit of any one of claims 213 to 219, wherein the actuator unit comprises an actuator connection, the actuator connection connecting the at least one actuator to the plate (optionally, the actuator connection is configured to be moveable in at least one degree of freedom (optionally one degree of freedom, or two degrees of freedom, or three degrees of freedom, or four degrees of freedom, or five degrees of freedom, or six degrees of freedom, or at least six degrees of freedom).

221. The actuator unit of any one of claims 213 to 220, wherein the at least one actuator(s) is/are configured to engage a compliant material (optionally at an end of the actuator).

222. The actuator unit of any one of claims 213 to 221, wherein the at least one actuator is configured to modify the profile of the compliant material.

223. The actuator unit of any one of claims 213 to 222, wherein the at least one actuator is one or more of: a robotic end effector, a vacuum actuator, a pneumatic actuator, a muscle actuator, a servo actuator, a hydraulic actuator, a voice coil actuator, a piezo actuator, a chain actuator.

224. The actuator unit of any one of claims 213 to 223, wherein the motor is one or more of: a stepper motor, a DC motor, an AC motor, an electronically controlled motor, a servo motor, a hybrid servo stepper motor, a muscle actuator, a pneumatic motor, a vacuum motor, a hydraulic motor, a voice coil motor, a piezo motor.

225. The actuator unit of any one of claims 213 to 224, wherein the actuator unit comprises a housing, the housing surrounding the at least one actuator(s).

226. The actuator unit of any one of claims 213 to 225, wherein the housing comprises at least one shaft aperture.

227. The actuator unit of any one of claims 213 to 226, wherein the motor is configured to be operatively connected to an end of the housing at the shaft aperture.
